(19) United States
(12) Patent Application Publication
(10) Pub. No.: US 2005/0077648 A1
(43) Pub. Date: Apr. 14, 2005

(54) Solution casting method and polymer film

(76) Inventor: Masaru Sugiura, Kanagawa (JP)

Correspondence Address: BIRCH STEWART KOLASCH & BIRCH, PO BOX 747, FALLS CHURCH, VA, 22040-0747, US

(21) Appl. No.: 10/959,132

(22) Filed: Oct. 7, 2004

(30) Foreign Application Priority Data
Oct. 8, 2003 (JP) 2003-349067

(51) Int. Cl. B29C 39/14; B29C 55/06

(52) U.S. Cl. 264/216; 264/288.4

(57) ABSTRACT

A solvent in which dichloromethane is mixed with alcohol as a poor solvent is used for preparing a dope. Alcohol is supplied to the dope in a inline pipe to mix with a static mixer, such as a casting dope in which a composition of alcohol is increased. The temperature of the rotary drum is adjusted to −7° C. The casting dope is fed from a casting die to the rotary drum so as to form a casting film whose thickness is 40 μm. Since the content of alcohol is high and a storage modulus of the cooled casting film is at least 150 thousands Pa, the peeling defect does not occur, and the stretch is reduced as far as possible. A gel-like film is dried by a tenter type drying device, and stretched such that the stretch ratio is at most 110%. The produced film is thin and excellent in a surface condition and optical isotropy.

### BACKGROUND OF THE INVENTION

1. Field of the Invention

The present invention relates to a solution casting method and a polymer film, and more especially to a polymer film which is thin and used as an optical film in a liquid crystal display and the like, and to a solution casting method for producing the polymer film.

2. Description Related to the Prior Art

As a liquid crystal display is made thinner and is driven under low voltage and low electric power, it is used in a mobile phone, a notebook computer, and the like. The liquid crystal display is most substantially constructed of a liquid crystal cell having liquid crystal molecules and two polarizing filters which are disposed in both sides of the liquid crystal cell such that the polarization axes may be perpendicular to each other. Recently, the liquid crystal display becomes more lightweight and thinner, and therefore it is required to make the polarizing filter and the like as construction elements of the liquid crystal display thinner.

The cellulose acylate film is usually used as a protective film for the polarizing filter, since being excellent in optical isotropy and moisture resistance. The polarizing filter is constructed of a polarized film whose components are polyvinyl alcohol and iodide complex, and cellulose acylate films which are adhered to both surfaces of the polarized film (Japan Institute of Invention and Innovation (JIII) JOURNAL of Technical Disclosure No.2001-1745). Therefore four cellulose acylate films are used in the one liquid crystal display.

In the recent trend to make the liquid crystal display more lightweight and thinner, it is extremely necessary to produce the thinner cellulose acylate film.

Further, in order to decrease the thickness of the cellulose acylate film with keeping a viewing angle characteristic of the liquid crystal display, it is necessary not to lose the optical properties of the cellulose acylate film. However, the thinner cellulose acylate film is produced in the same solution casting method as the prior art with keeping the optical properties, the productivity becomes worse.

### SUMMARY OF THE INVENTION

An object of the present invention is to provide a polymer film and a solution casting method for producing the polymer film which is excellent in optical properties and has a thickness in the range of 10 μm to 60 μm.

In order to achieve the object and the other object, in a solution casting method for producing a polymer film whose thickness is from 10 μm to 60 μm of the present invention, the dope containing polymer is cast on a support so as to form a casting film having storage modulus of at least 150,000 Pa. The casting film is peeled as the polymer film from the support. Preferably a temperature of the support is at least −5° C.

In a preferable embodiment of a solution casting method of the present invention, a dope containing polymer is cast on a support to form a casting film, which is peeled as the polymer film from the support. The polymer film is stretched such that a stretch ratio of the polymer film in a casting direction may be 110%.

A polymer film of the present invention satisfies conditions that a transmittance speed C1 of sonic wave in a casting direction is at most 2.65 km/sec, and that a transmittance speed C2 of sonic wave in a widthwise direction perpendicular to the casting direction is at least 2.20 km/sec.

According to a solution casting method of the present invention, since the storage modulus is regulated to at least 150,000 Pa and can be easily increased, the stretch of the polymer film in effect of a peeling stress is reduced, and the polymer molecules are randomly oriented. Accordingly the polarization caused by the orientation of the polymer molecules hardly occurs, and the film of the excellent optical properties can be obtained.

According to the polymer film of the present invention, since the TAC molecules are randomly oriented, the Re value is at most 10 nm. Therefore the polymer film is excellent in the optical isotropy.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a first embodiment of a film production line to which a solution casting method of the present invention is applied;

FIG. 2 is an exploded partial view of an inline pipe used in the film production line;

FIG. 3 is a second embodiment of the film production line to which a solution casting method of the present invention is applied;

FIG. 4 is a schematic view illustrating a situation of casting a dope;

FIG. 5 is a similar schematic view illustrating a situation of casting the dope;

FIG. 6 is a similar schematic view illustrating a situation of casting the dope.

### PREFERRED EMBODIMENTS OF THE INVENTION

[Polymer]

When a produced film is used as an optical film for a liquid crystal display (LCD), it is necessary that the film has an excellent optical isotropy, a low permeability, a stable view angle property, and a small film thickness (for example from 10 μm to 60 μm). A preferable material of the film satisfying these conditions is cellulose acylate, particularly cellulose acetate. The degree of acetylation of the cellulose acylate is preferably in the range of 57.5% and 62.5% (or 2.6 to 3.0), and especially preferably in the range of 58.8% and 61.3% (or 2.7 to 2.9). Note that the cellulose acylate is called TAC in the following explanation.

When chlorine type organic solvent is used as the solvent for the dope, the degree of acetylation is preferably 2.8 to 2.85. Further, in this case, the degree of acetylation at 6^{th} position is preferably 0.8 to 0.97. Note that raw materials of the cellulose triacetate are cotton linter and wood pulp, and one of them can be used and a mixture thereof can be used in the present invention. The percent acetyl value is measured and calculated in ASTM:D-817-91 (testing method for cellulose acylate and the like). The acetyl value means a degree in mass of acetic acid combined with cellulose polymer. As the degree of substitution, a value calculated from the degree of acetylation is used.

In an embodiment of the present invention, the cellulose acylate particles may be used. At least 90 wt. % of the cellulose acylate particles have diameter in the range of 0.1 mm to 4 mm, preferably in the range of 1 mm to 4 mm. Further, it is preferable that the ratio of the cellulose acylate particles having diameter in the range of 0.1 to 4 mm is preferably at least 95 wt. % of the cellulose acylate particles, particularly at least 97 wt. %, especially at least 98 wt. %, and most especially at least 99 wt. %. Furthermore, it is preferable that at least 50 wt. % of the cellulose acylate particles have diameter in the range of 2 mm to 3 mm. The ratio of the cellulose acylate particles having diameter in the range of 2 mm to 3 mm is particularly at least 70 wt. %, especially at least 80 wt. %, and most especially at least 90 wt. %. Preferably, the cellulose acylate particle has a nearly ball-like shape.

[Solvent]

(Solvent for Preparing Dope)

When the dope is prepared, both of chlorine type organic solvent and non-chlorine type organic solvent may be used. As the chlorine type organic solvent is usually halogeneted hydrocarbon materials, whose representative examples are dichloromethane (methylene chloride) and chloroform. However, the chlorine type organic solvent is not restricted in them. The chlorine type organic solvent has a high solubility of TAC and a good solvent. Further, alcohols (for example methanol, ethanol, n-butanol (note that in the present invention butanol means n-butanol so far as an explanation is not especially made) has low solubility of TAC than the chlorine type organic solvent, and is therefore called a poor solvent. A mixture solvent may be used, in which the chlorine type organic solvent (for example dichloromethane) as the main solvent and other solvent components are mixed. Otherwise, only the chlorine organic solvent may be used, namely 100 wt. %.

When the dope is prepared, only the non-chlorine type organic solvent may be used. Although the chlorine type organic solvent (dichloromethane) is a good solvent to which the TAC easily dissolves, harmful influences on human bodies and circumstances are concerned.

As the nonchlorine type organic solvent, there are, for example, esters (for example, methyl acetate, methyl formate, ethyl acetate, amyl acetate, butyl acetate and the like), ketones (for example, acetone, methylethyl ketone, cyclohexanone), ethers (for example, dioxane, dioxolane, tetrahydrofrane, diethylether, methyl-tert-butylether, and the like), alcohol (for example, methanol, ethanol, butanol and the like). The non-chlorine type organic solvent is not restricted in them. As the good solvent in the non-chlorine type organic solvent of TAC, there are esters (mainly methyl acetate), ketones (mainly acetone) and the like. As the poor solvent, there are alcohols. A mixture solvent in which the good solvent and other solvent components are mixed may be used, and otherwise only the good solvent can be used. Further, since the non-chlorine organic solvent usually tends to contain water, it is preferable to make a dehydration treatment so far as it does not influence on the film production.

(Additional Solvent)

In order to increase the content of the poor solvent components, it is preferable to add to the dope an additional solvent composed of the poor solvents compounds. Thus when the dope is prepared, the concentration of the good solvent components is large such that the TAC easily dissolved to the solvent, and therefore the time for dissolution becomes shorter. Then the prepared dope is used as a casting dope for forming a casting layer. When the casting film contains the concentration of the poor solvent components in the solvent just before the peeling, the storage modulus becomes larger, and the peeling defect is prevented. The explanation thereof is made in the followings. Further, as the solvent for preparing the dope and the additional solvent, a solvent in the market or the recovered solvent may be used. Note that these solvents are purified so far as it doesn't influence on the film properties.

Preferably, compounds of the additional solvent are alcohols, and especially alcohols in which number of carbons is at most 4 (for example, methanol, ethanol, butanol and the like). The alcohols have large compatibility to TAC, and therefore don't causes the denaturalization of TAC. Further, the solvent to which the polymer is dissoluble and a mixture solvent of wide content ratio can be obtained, influences on human bodies are small, and environment conservation is excellent. Further, the steam pressure is higher than that of other solvent, and since additional solvent tends to remain in the casting film, the effect can be obtained for increasing the storage modulus at the peeling. The additional solvent contains only the poor solvent components, or both of the poor solvent components and the good solvent components. Further, the polymers (such as TAC and the like) and the additives may be added to the additional solvent, according to the experimental conditions. Note that the quantity of the additional solvent is adequately determined from the component of the solvent in the prepared dope and the preferable component of the solvent in the casting dope.

[Additives]

Plasticizer, UV-absorptive material, deterioration inhibitor may be added as the additives to the dope solution. As the plasticizer used in the present invention, there are phosphoric acid ester type (for example triphenylphosphate (TPP), tricresylphosphate, cresyldiphenylphosphate, octyldiphenylphosphate, diphenylbiphenyl phosphate (BDP), trioctylphosphate, tributylphosphate and the like), phthalic acid ester type (for example diethylphthalate, dimethoxyethylphthalate, dimethylphthate, dioctylphthalate and the like), grycolic acid ester type (for example, triacetine, tributyline, butylphthalylbutylglycolate, ethylphthalylethylglycolate, methylphthalylethylglycolate, butylphthalylbutylglycolate and the like). However, the plasticizers are not restricted in them.

As the UV-absorbing agent, there are, for example, oxybenzophenone type compounds, benzotriasol type compounds, salicylic acid ester type compounds, benzophenone type compounds, cyanoacrylate type compounds, nickel complex salt type compounds. Particularly preferable are benzotriasol type compounds and benzophenone type compounds. Especially preferable are benzotriazol type compounds, as they don't unexpectedly carry out the coloring of the cellulose ester. Furtherthere are UV-absorbing agent of benzotriasol type compounds disclosed in Japanese Patent-Laid Open Publication No. H08-29619 and UV-absorbing agent disclosed in Japanese Patent Laid-Open Publication No. H08-239509. Ultraviolet absorptive materials may be added in the dope solution. Especially the dope solution may contain one or more sorts of ultraviolet absorptive materials. The ultraviolet absorptive material uses for a film in the liquid crystal display should effectively absorb ultraviolet ray under 370 nm of wave length in view of preventing deterioration of the liquid crystal, and hardly absorb visible ray above 400 nm of wave length in view of indication probability of the liquid crystal.

As the preferable UV-absorbing agent, there are, 2,6-di-tert-butyl-p-crezol, pentaerythrytyl-tetrakis[3-(3,5-di-tert-butyl-4-hydroxyphenyl)propionate], triethyleneglycol-bis[3-(3-tert-butyl-5-methyl-4-hydroxyphenyl)propionate], 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triazine, 2,2-thio-diethylenebis[3-(3,5-di-tert-butyl-4-hydroxyphenyl)propionate], 2(2′-hydroxy-3′,5′-di-tert-butylphenyl)-5-chlorobenzotriazol, 2(2′-hydroxy-3′,5′-di-tert-amylphenyl)-5-chlorobenzotriazol, octadecyl-3-(3,5-di-tert-butyl-4-hydroxyphenyl)propionate, N,N′-hexamethylenebis(3,5-di-tert-butyl-4-hydroxy-hydrocynenamide), 1,3,5-trimethyl-2,4,6-tris(3,5-di-tert-butyl-4-hydrozybenzil)benzene, tris(3,5-di-tert-butyl-4-hydroxybenzil)-isocianulate, and the like. Especially preferable are 2,6-di-tert-butyl-p-crezol, pentaerythrytyl-tetrakis[3-(3,5-di-tert-butyl-4-hydroxyphenyl)propionate], triethyleneglycol-bis[3-(3-tert-butyl-5-methyl-4-hydroxyphenyl)propionate]. Further, metal deactivators of hydradine compounds (such as N,N′-bis[3-(3,5-di-tert-butyl-4-hydroxyphenyl)propionyl]hydradine and the like), and phosphate processing stabilizer (such as tris(2,4-di-tert-butylphenyl)phosphate and the like) may be mixed and used.

The dope solution preferably contains matting agent (particle powders) for improving an adhering endurance property under high moisture and a slipping property of the film. An averaged height of umbones of the matting agent on a surface is preferably 0.005-10 μm, particularly 0.01-5 μm. The number of the umbones is preferably large. However, when it is larger than necessary, the umbones cause the haze. Further, the primary diameter of the particle is preferably 1 nm to 500 nm. However, the present invention is not restricted in the description. The matting agent may be inorganic and organic compounds. As inorganic matting agents, there are inorganic particles, such as barium sulfate, manganese colloid, titanium dioxide, strontium sulfate, silicon oxide type (silicon dioxide and the like), aluminum oxide, zinc oxide, tin oxide, calcium carbonate, barium sulfate, talc, caoline, calcium sulfate. Further, there are silicone dioxide, (for example synthetic silica obtained in wet processing or by gelating silicic acid) and titanium dioxide (rutile type, anatase type) produced from titanslag and sulfuric acid.

The inorganic matting agent may be obtained also by milling inorganic compound whose diameter is more than 20 μm. In this case, after the milling, the classification of inorganic compound is carried out for example by vibrating filtration, wind power classification.

As the organic compound, there are organic polymer compounds which is milled and classified, for example, polytetrafluoroethylene, cellulose acetate, polystyrene, polymethyl methacrylate, polypropyl methacrylate, polymethyl acrylate, polyethylene carbonate, acrylstyrene type resins, silicone type resins, polycarbonate type resins, benzoguanamine type resins, melamine type resins, polyolefin type powders, polyester type resins, polyamide type resins, polyimide type resins, polyfluoroethylene type resins and starch. There are further polymer synthesized in suspension polymerization, polymers having ball shape that are obtained in spray drying method or dispersing method, and inorganic compounds. However, when the amount of the particle powders is too large in the dope solution, the flexibility of the film becomes lower. Accordingly, the dope solution preferably contains the particle powders in 0.01 wt. %-5 wt. % to the polymer.

[Mold Lubricant]

Mold lubricants are often added to the dope in order to make the molding more easily. In the mold lubricants there are waxes having high boiling points, higher aliphatic acid and salt form thereof, esters, silicone oil, polyvinyl alcohol, low molecular weight polyethylene, derivatives of vegitable proteins and the like. However, the present invention is not restricted in them. It is preferable to adjust the quantity of mold lubricant to be added such that the weight percentage of the mold lubricant to the polymers in the dope may be in the range of 0.001 wt. % to 1 wt. %, since the mold lubricants have influences on the brilliance and smoothness of the film.

[Fluorine Type Surface Active Agent]

In the dope, fluoride surface-active agents may be also added. The fluoride surface-active agents have a hydrophobic group of fluorocarbon chain, and therefore is used as casting agent in organic solvent or a antistatic agent while it decreases a surface tension. As the fluoride surface-active agent there are, for example, C₈F₁₇CH₂CH₂O—(CH₂CH₂O)₁₀—OSO₃Na, C₈F₁₇SO₂N(C₃H₇)(CH₂CH₂O)₁₆—H, C₈F₁₇SO₂N(C₃H₇)CH₂COOK, C₇F₁₅COONH₄, C₈F₁₇SO₂N(C₃H₇)(CH₂CH₂O)₄—(CH₂)₄—SO₃Na, C₈F₁₇SO₂N(C₃H₇)(CH₂)₃—N⁺(CH₃)₃.I⁻, C₈F₁₇SO₂N(C₃H₇)CH₂CH₂CH₂N⁺(CH₃)₂—CH₂COO⁻, C₈F₁₇CH₂CH₂O(CH₂CH₂O)₁₆—H, C₈F₁₇CH₂CH₂O(CH₂)₃—N⁺(CH₃)₃.I⁻, H(CF₂)₈—CH₂CH₂OCOCH₂CH(SO₃)COOCH₂CH₂CH₂CH₂—(CF₂)₈—H, H(CF₂)₆CH₂CH₂O(CH₂CH₂O)₁₆—H, H(CF₂)₈CH₂CH₂O(CH₂)₃—N⁺(CH₃)₃.I⁻, H(CF₂)₈CH₂CH₂OCOCH₂CH (SO₃)COOCH₂CH₂CH₂CH₂C₈F₁₇, C₉F₁₇—C₆H₄—SO₂N(C₃H₇)(CH₂CH₂O)₁₆—H, C₉F₁₇—C₆H₄—CSO₂N(C₃H₇)—(CH₂)₃—N⁺(CH₃)₃.I⁻. The amount of the fluoride surface active agent in the dope solution is preferably 0.001-1 wt. % to the polymer.

[Release Agent]

The release agents may be added to the dope so as to decrease the peeling force. As the release agent, surface-active agents are especially preferable. There are phosphoric acid type, sulfonic acid type, carboxylic acid type, nonionic type, cationic type and the like in the release agent. However the release agents are not restricted in them. These releasing agents are described in Japanese Patent Laid-Open Publication No. 61-243837. Further, Japanese Patent Laid-Open Publication No. 57-500833 teaches polyethoxylic phosphoric acid ester as release agent. In the Japanese Patent Laid-Open Publication No.61-69845, the peeling is smoothlymade by adding to cellulose ester mono/diphosphoric acid alkylester in which non-esterified hydroxylic group has a free acid form. Further, in Japanese Patent Laid-Open Publication No.1-299847, a peeling force is decreased by adding inorganic particles and phosphoric acid ester compounds having non-esterified hydroxylic group and propyreneoxide chain. These materials can be used as the release agent. The amount of the release agent is 0.001 wt. %-1 wt. % to the polymers.

[Deterioration Inhibitor]

Further, deterioration inhibitors (antioxidant, peroxide decomposer, radical inhibitor, metal deactivator, acid capture, amine and the like) and UV-stabilizer may be added to the dope. Such deterioration inhibitors and UV-stabilizers are disclosed in Japanese Patent Laid-Open Publication No.60-235852, 3-199201, 5-1907073, 5-194789, 5-271471, 6-107854, 6-118233, 6-148430, 7-11056, 7-11055, 7-11056, 8-29619, 8-239509 and 2000-204173. The especially preferable deterioration inhibitor is butylized hydroxyl toluene (BHT). Further, it is preferable to prepare the polymer solution which contains 0.01 wt. % to 5 wt. % deterioration inhibitor to the polymer.

(Retardation Adjuster)

In the present invention, retardation adjuster may be added to the dope for controlling the optical anisotropy. Aromatic compounds having at least two aromatic groups are preferably used as the retardation adjuster. Further, at least two sorts of aromatic compounds may be simultaneously used. In the aromatic group of the aromatic compounds, there are not only the aromatic hydrocarbon group, but also heterocyclic group having character of aromatic hydrocarbon. Note that it is preferable to prepare the polymer solution which contains 0.01 wt. % to 10 wt. % retardation adjuster to the polymer.

The aromatic hydrocarbon group is especially preferably 6-membered ring (benzene ring). The aromatic hetero ring is usually unsaturated hetero ring, and preferably 5-membered ring, 6-membered ring, or 7-membered ring, and especially preferably 5-membered ring, or 6-membered ring. Usually, double bonds in the heterocyclic group having character of aromatic hydrocarbon is formed at the largest number (or the maximal number). As hetero atoms used in the present invention, nitrogen atom, oxygen atom, and sulfer atom are preferable, and nitrogen atom is especially preferable. As the heterocyclic group having character of aromatic hydrocarbon, there are furan ring, thiophene ring, pyrrol ring, oxazol ring, isooxazol ring, thiazol ring, isothiazol ring, imidazol ring, pyrazol ring, furazan ring, triazol ring, pyran ring, pyridine ring, pyridazine ring, pyrimidine ring, pyradine ring, and 1,3,5-triadine ring and the like.

(Oil-Gelation Agent)

In the present invention, as explained in detail, it is preferable to add an Oil-gelation agent to the dope in order to change the physical properties of the dope. The well known oil-gelation agent may be used. However, the preferable oil-gelation agent of the present invention is described in the publications (for example, J.Chem.Soc.Japan, Ind.Chem.Soc., 46,779 (1943); J.Am.Chem.Soc., 111,5542 (1989); J.Chem.Soc., Chem.Commun., 1993,390; Angew.Chem.Int.Ed.Engl., 35,1949 (1996); Chem.Lett., 1996,885; J.Chem.Soc., Chem.Commun., 1997,545). Further, the preferable oil-gelation agents are described as the gelation agent or the oil-gelation agent in KOBUNSHI RONBUNSHU (Japanese Journal of Polymer Science and Technology, VOL.55,No.10,585-589(October,1998)), HYOUMEN (Surface: VOL.36,No.6,291-303(1998)), Sen'i to Kogyo (Journal of the Society of fiber science and technology, VOL.56,No.11,329-332(2000)); Japanese Paten-Laid Publications No. 7-247473, 7-247474, 7-247475, 7-300578, 10-265761, 7-208446, 2000-3003, 5-230435, 5-320617.

The oil-gelation agent may be others than the above described ones. However, the oil-gelation agents are not restricted in them. For example, sugars to which aromatic groups having 6-100 carbon atoms or a aliphatic groups having 5-100 carbon atoms are bound, aliphatic acids having 5-100 carbon atoms, amino acids having 5-100 carbon atoms, ring dipeptidos having 5-100 carbon atoms, esters of amido or steroid structure having 5-100 carbon atoms, phenols having 6-100 carbon atoms, ether having 5-100 carbon atoms, lactones to which aromatic groups having 6-100 carbon atoms or a aliphatic groups having 5-100 carbon atoms are bound, urea derivatives to which aromatic groups having 6-100 carbon atoms or a aliphatic groups having 5-100 carbon atoms are bound, biotin (vitamin H) derivatives to which aromatic groups having 6-100 carbon atoms or a aliphatic groups having 5-100 carbon atoms are bound, aldonic acid derivatives to which aromatic groups having 6-100 carbon atoms or a aliphatic groups having 5-100 carbon atoms are bound, barbituric acids to which aromatic groups having 6-100 carbon atoms or a aliphatic groups having 5-100 carbon atoms are bound, aliphatic heterocyclic compounds to which aromatic groups having 6-100 carbon atoms or a aliphatic groups having 5-100 carbon atoms are bound, and aliphatic cyclic compounds to which aromatic groups having 6-100 carbon atoms or a aliphatic groups having 5-100 carbon atoms are bound.

The aliphatic groups includes alkyl groups, substituted alkyl groups alkenyl group, substituted alkynyl group, alkynyl group, and substituted alkynyl group. The alkyl group may be cycle (cycloalkyl group), and have branches.

The alkyl part of the substituted alkyl groups, substituted alkenyl groups and substituted alkynyl groups are respectively the same as the alkyl groups, alkenyl groups and alkynyl groups. As substitutions on the substituted alkyl groups, substituted alkenyl groups and substituted alkynyl groups, there are halogene atoms, hydroxyl groups, formyl groups, carboxyl groups, amino groups, carbamoyl groups, sulfamoyl groups, ureido groups, aliphatic groups, complex cyclic groups, —O—R, —CO—R, —CO—O—R, —O—CO—R, —NH—R, —NR—R′, —CO—NH—R′, —CO—NH—R, —CO—NR—R′, —SO₂—NH—R, and —SO₂—NR—R′. R and R′ are aliphatic groups, aromatic groups and complex cyclic groups, and they may have the same or different substituents.

The aromatic groups are aryl groups or substituted aryl groups. The aryl groups are phenyl and naphtyl groups. The aryl part of the substituted aryl groups are the same as the aryl groups. As substitutions on the substituted aryl groups, there are halogene atoms, hydroxyl groups, formyl groups, carboxyl groups, amino groups, carbamoyl groups, sulfamoyl groups, aliphatic groups, aromatic groups, complex cyclic groups, —O—R, —CO—R, —CO—O—R, —O—CO—R, —NH—R, —NR—R′, —CO—NH—R′, —CO—NH—R, —CO—NR—R′, —SO₂—NH—R, and —SO₂—NR—R′. R and R′ are aromatic groups and complex cyclic groups. The heterocyclic rings of the heterocyclic groups are 5-membered rings, 6-membered rings, or condensation rings of them. The substituents of the substituted aryl groups are the same as those of the substituted aryl groups.

The aromatic groups and aliphatic groups are obtained by connecting sugar alcohols, lactones, urea, biotins, aldonic acids, barbituric acids and the aromatic hetero cyclic compounds or aliphatic compounds directly to each other or through connection groups. The connection groups are —NH—, —O—, —CO—, or combinations of them.

The sugars may be the sugar alcohols. The preferable sugars are glucose and lactose. The preferable sugar alcohol is sorbitol. As the examples of the sugars and the sugar alcohols to which aromatic groups having 6-100 carbon atoms or aliphatic groups having 5-100 carbon atoms are bound, there are 1,2,3,4-dibendilidene-D-sorbitol, 4-aminophenyl-α-D-glucopyranoside, 4-aminophenyl-α-D-galactopyranosid, 4-aminophenyl-α-D-mannopyranosid, 4-aminophenyl-β-D-glucopyranoside, 4-aminophenyl-β-D-galactopyranosid, 2-aminophenyl-β-D-glucopyranosid, 2-aminophenyl-β-D-galactopyranosid, 4-aminophenyl-2-O,3-O,4-O,6-O-tetraacetyl-β-D-glucopyranoside, 4-aminophenyl-2-O,3-O,4-O,6-O-tetraacetyl-β-D-galactopyranosid, 4-aminophenyl,4-O,6-O-benzylidene-α-D-glucopyranoside, 4-aminophenyl-4-O,6-O-benzylidene-α-D-galactopyranosid, 4-aminophenyl,4-O,6-O-benzylidene-β-D-glucopyranoside, methyl-4-O,6-O-benzylidene-α-D-glucopyranoside, methyl-4-O,6-O-benzylidene-β-D-glucopyranoside, methyl-4-O,6-O-benzylidene-α-D-galactopyranosid, methyl-4-O,6-O-benzylidene-β-D-galactopyranosid, methyl-4-O,6-O-benzylidene-α-D-mannopyranosid, 1-O,3-O:2-O,4-O-bis(benzylidene)-D-sorbitol, 1-O,3-O:2-O,4-O-bis(benzylidene)-5-O-methyl-D-sorbitol, 1-O,3-O:2-O,4-O-bis(benzylidene)-6-O-methyl-D-sorbitol, and the like.

The aliphatic acid may has substituents (for example, hydroxyl group). As the aliphatic acids having 5-to carbon atoms, there are 12-hydroxystearic acid.

Amino acids having5-100 carbon atoms may have a molecular structure in which aromatic groups or aliphatic groups are bound to the usual (or natural) amino acid. As the amino acids having 5-100 carbon atoms, N-lauroyl-L-glutamic acid-α, lauroyl glutamic acid laurylamine salts, lauroyl glutamic acid dilaurylesters, dicapliroyl lidine laurylamine salts, dicapliroyl lidine laurylesters, and lauroyl phenylalanine laurylamine salts.

Cyclic dipeptide having 5-100 carbon atoms are formed from two amino acids selected from groups which are obtained from valin, leucine, isoleucine, aspartic acid, aspargic acid esters, glutamic acid, glutamic acid esters and phenylalanine. As the cyclic dipeptide having 5-100 carbon atoms, there are, for example, 3α-methylpiperazine-2,5-dion, 3α-isopropylpiperazine-2,5-dion, 3α-(2-methylpropyl)piperazine-2,5-dion, 3α-benzylpiperazine-2,5-dion, 3α-phenylpiperazine-2,5-dion, 3α,6α-diisopropylpiperazine-2,5-dion, 3α-(2-methylpropyl)-6α-isopropylpiperazine-2,5-dion, 3α,6α-bis(2-methylpropyl)piperazine-2,5-dione, 3α-(2-methylpropyl)-6α-benzylpiperazine-2,5-dion, 3α,6α-dibenzilpiperazine-2,5-dione, 3-(3,6-dioxopiperazine-2β-il)propanic acid ethyl, 3-(5β-isopyprl-3,6-dioxopiperazine-2β-il)propanic acid ethyl), 3-(5β-isopypyl-3,6-dioxopiperazine-2β-il)propanic acid dodecy), 3-(5β-isopypyl-3,6-dioxopiperazine-2β-il)propanic acid octadecyl), 3-(5β-isopypyl-3,6-dioxopiperazine-2β-il)propanic acid-3,7-dimethylactyl, 3-(5β-isopypyl-3,6-dioxopiperazine-2β-il)propanic acid-2-ethylhexyl, 3-[5β-(2-methylpropyl)-3,6-dioxopiperazine-2β-il]propanic acid ethyl, 3-[5β-(2-methylpropyl)-3,6-dioxopiperazine-2β-il]propanic acid dodecyl, 3-[5β-(2-methylpropyl)-3,6-dioxopiperazine-2β-il]propanate-3,7-dimethyloctyl, 3-[5β-(2-methylpropyl)-3,6-dioxopiperazine-2β-il]propanic acid benzyl, 5β-benzyl-3,6-dioxopiperazine-2β-acetic acid, 5β-benzyl-3,6-dioxopiperazine-2β-acetic acid butyl, 5β-benzyl-3,6-dioxopiperazine-2β-acetic acid dodecyl, 5β-benzyl-3,6-dioxopiperazine-2β-acetic acid-3,7-dimethyl octyl, 5β-benzyl-3,6-dioxopiperazine-2β-acetic acid-2-ethylhexyl, 5β-benzyl-3,6-dioxopiperazine-2β-acetic acid-3,5,5-trimethylhexyl, and 5β-benzyl-3,6-dioxopiperazine-2′-acetic acid-2-ethylbutyl.

As amides having 5-100 carbon atoms in one molecule, there are γ-bis-n-butylamide, 3,5-tris[phenyl[4-[(1-oxooctadecyl)amino]phenyl]amino]benzene, tris[4-phenyl[4-[(1-oxooctadecyl)amino]phenyl]amino]phenyl]amine, 5,5-dimethylhydantoin, N,N′-(1,12-dodecandiyl)bis[N-α-(benzyloxycarbonyl)-L-valine amide], N,N′-(1,12-dodecandiyl)bis[N-α-(etoxycarbonyl)-L-isoleucine amide], N,N′-ethylenebis[N-α-(etoxycarbonyl)-L-valine amide], N,N′,N″-tripropylbenzene-1,3,5-tricarboamide, N,N′,N″-trioctylbenzene-1,3,5-tricarboamide, N,N′,N″-tridodecylbenzene-1,3,5-tricarboamide, N,N′,N″-trioctadecylbenzene-1,3,5-tricarboamide, N,N′,N″-tris(3,7-dimethyloctyl)benzene-1,3,5-tricarboamide, N,N′,N″-tris(1-hexylnonyl)benzene-1,3,5-tricarboamide, lauroyl glutamic acid dibutyl amide, lauroyl glutamic acid distearyl amide, lauroyl valine butylamide, lauroyl phenylalanine laurylamide, and dicapliloyllidine laurylamide.

Esters having steroid structure includes spin-labeled steroid, cholesterol derivatives, and cholic acid derivatives. As the esters having steroid structure, there are N-ε-lauloyl-N-a-stealilaminocarbonyl-L-lidineethyl(4-α-D-glucopyranosylphenyl)carbamic acid cholesta-5-en-3β-il, (4-α-D-galactopyranosylphenyl)carbamic acid cholesta-5-en-3β-il, (4-α-D-mannopyranosylphenyl)carbamic acid cholesta-5-en-3β-il, (4-β-D-glucopyranosylphenyl)carbamic acid cholesta-5-en-3β-il, (4-β-D-galactopyranosylphenyl)carbamic acid cholesta-5-en-3β-il, (2-β-D-glucopyranosylphenyl)carbamic acid cholesta-5-en-3β-il, (2-β-D-galactopyranosylphenyl)carbamic acid cholesta-5-en-3β-il, [4-(2-O,3-O,4-O,6-O-tetraacetyl-β-D-glucopyranosyl)phenyl]carbamic acid cholesta-5-en-3β-il, [4-(2-O,3-O,4-O,6-O-tetraacetyl-β-D-galactopyranosyl)phenyl]carbamic acid cholesta-5-en-3β-il, N,N′-hexamethylenebis[4-(3β-cholesteryl)oxy]-4-oxobutane amide, N,N′-(heptame-1,7-diyl)bis[4-(3β-cholesteryl)oxy]-4-oxobutane amide, N,N′-(octame-1,8-diyl)bis[4-(3β-cholesteryl)oxy]-4-oxobutane amide, N,N′-(nonane-1,9-diyl)bis[4-(3β-cholesteryl)oxy]-4-oxobutane amide, N,N′-(decame-1,10-diyl)bis[4-(3β-cholesteryl)oxy]-4-oxobutane amide, N,N′-(dodecame-1,12-diyl)bis[4-(3β-cholesteryl)oxy]-4-oxobutane amide, N,N′-[trimethylenebis[carbonylimino(pyridine-2,6-diyl)]bis(carbamide acid-3-cholesterlyl) and, N,N′-[m-phenylenebis[carbonylimino(pyridine-2,6-diyl)]bis(carbamate-3-cholesteryl.

Phenols having 6-100 carbon atoms may form cyclic oligomers. The ethers having 5-100 carbon atoms includes 2,3-bis-n-hexadecyloxycianthracene. The lactone to which aromatic group having 6-100 carbon atoms and aliphatic group having 5-100 carbon atoms is especially preferably butyllactone.

Ureas to which aromatic group having 6-100 carbon atoms and aliphatic group having 5-100 carbon atoms includes, for example, 1,1′-benzylidene bis(3-butylurea), 1,1′-benzylidene bis(3-benzylurea), 1,1′-(4-chlorobenzylidene)bis(3-butylurea), 1,1′-(4-methoxybenzylidene)bis(3-butylurea), 1,1′-[4-(dimethylamino)benzylidene]bis(3-butylurea), 1,1′-benzylidenebis(3-metylurea), 1,1′-[(1S,2S)-cyclohexane-1,2-diyl]bis(3-undecylurea), 1,1′-[(1R,2R)-cyclohexane-1,2-diyl]bis(3-undecylurea), 1,1′-[(1R,2R)-cyclohexane-1,2-diyl]bis[3-(1-ethylpentyl)urea], 1,1′-[(1R,2R)-cyclohexane-1,2-diyl]bis[3-[3-(2-thienyl)propyl]urea], 4,4′-[(1R,2R)-cyclohexane-1,2-diyl]bis(iminocarbonylimino)]bis[butalic acid-2-(oxo-2-methyl-2-propenyloxy)ethyl], 1,1′-[(1R,2S)-cyclohexane-1,2-diyl]bis(3-undecylurea), 1,1′-(1,2-phenylen)bis(3-undecylurea), 1,1′-(1,2-phenylen)bis(3-cyclohexylurea), 1,1′-(1,2-phenylen)bis[3-(3-phenylpropyl)lurea], 1,1′-(1,2-phenylen)bis[3-[3-(2-thienyl)propyl]lurea], 1,1′-(1,3-phenylen)bis(3-undecylurea), 1,1′-(1,4-phenylen)bis(3-undecylurea), 1-benzyl-3-octylurea, 1-benzyl-3-cyclohexylurea, 1-benzyl-3-(1-phenylethyl)urea, 3,3′-(propane-1,3-diyl)bis(1-benzylurea), 3,3′-(hexane-1,6-diyl)bis(1-benzylurea), 3,3′-(nonane-1,9-diyl)bis(1-benzylurea), 3,3′-(dodecane-1,12-diyl)bis(1-benzylurea).

Aldonic acid derivatives to which aromatic group having 6-100 carbon atoms and aliphatic group having 5-100 carbon atoms are preferably aldonic acid and gluconic acid. Heterocyclic compounds to which aromatic group having 6-100 carbon atoms and aliphatic group having 5-100 carbon atoms are especially preferably triaminopyrimidine. Alicyclic compounds to which aromatic group having 6-100 carbon atoms and aliphatic group having 5-100 carbon atoms are especially preferably cyclohexane.

The oil-gelation agent preferably has a structure of α-aminolactum. Further, rac-(4aα*,8aβ*)-tetrahydro-2α*,6β*-diphenyl4β*-[(R*)-1,2-dihydroxyethyl][1,3]dioxyno[5,4-d]-1,3-dioxyne can be uses as the oil-gelation agent. Further, in the present invention, the quantity of the oil-gelation agent to be added is not especially restricted.

The additives may be added when or after the polymer is dissolved to the solvent. Further, a solution in which the additives are previously dissolved to the solvent may be added to the prepared dope. In this case, the addition is made in a batch method or continuously in an inline method.

[Preparation of Dope]

After the polymer and the necessary additives are added into the solvent, the dissolution is made in sell known dissolving method such that the prepared dope may be obtained. Usually, the dope after the dissolution is filtrated to remove foreign materials or undissolved materials. As materials of the filters, there are known filter materials, such as filter paper, filter cloth, non-woven cloth, metal mesh, sintered metal filter, porous plate, and the like. The filtration removes the foreign materials and undissolved materials, such that the produced film may hardly or never have the descent of the quality, the damage or the defects to the products.

Further, the dope after the dissolution may be heated to make the dissolubility higher. In order to heat the dope, there are a method for heating with stirring the dope in a tank stationary disposed, a method for heating with feeding the dope with use of several sorts of heat exchangers, such as a multi pipe type or a jacket pipe with static mixers. Further, after the heating process, a cooling process may be provided. In the heating process, the inner pressure is made higher such that the temperature of the dope may be made higher than a boiling point under the atmosphere pressure. Thus in these processes, the undissolved micro particles are dissolved perfectly or to have a small size which can be ignored for the practical use. Thus the number of the foreign particles is reduced to filtrate with a lower filtration pressure.

The polymer concentration of the prepared dope (=(polymer weight/dope weight)×100) is not restricted especially. However, it is preferable in the range of 15 wt. % and 25 wt. %, especiallyl 19 wt. % and 23 wt. %. Further, the content of good solvent in the solvent of the prepared dope is in the range of 60 wt. % to 100 wt. % when the dichloromethane is used as the bad solvent. Further, the content of the methylacetate as the good solvent is preferable in the range of 60 wt. % and 100 wt. % when the non-chlorine type organic solvent. Further, acetone may be mixed such that the concentration in the solvent may be at most 40 wt. %.

[Addition of Acid Compounds]

In the prepared dope, there are undissolved particles whose size is too small to have no influence on a film produced from this prepared dope. However, the undissolved particle sometimes stop the filtration device. Accordingly, when the prepared dope is produced, it is preferable to add a small quantity of the acid compounds to the prepared dope in order to prevent the undissolved particles from stopping the flow of the dope in the filtration device. As the acid comounds, concretely, there are inorganic acids (for example, hydrochloric acid, and the like), and organic acids, such as carboxylic acids (for example acetic acid, lactic acid), polycarboxylic acids (for example citric acid, tartaric acid), derivatives of polycarboxylic acids, other organic acids (for example phenol), and the like. However, the acid compounds are not restricted in them. The standard structure of the derivative molecules of polycarboxylic acids is alifatic hydrocarbon structure (such as saturated linear- and branched-chain hydrocarbon group, unsaturated linear- and branched-chain hydrocarbon group, monocyclic hydrocarbon group, aromatic hydrocarbon group, condensed polycyclic group, bridged ring hydrocarbon group, spiro hydrocarbon group, ring assemblies, terpene hydrocarbon group and the like), aromatic hydrocarbon structure (aromatic hydrocarbon group, condensed ring hydrocarbon group), heterocyclic hydrocarbon structure (hetero ring).

Further, the derivative of polycarboxylic acid includes at least one salt of carboxylic acid (—COOM; M is ionized to becomes positive ion). For example, as the derivatives, there is a citric acid-1-ethyl ester (carboxyl group on a carbon atom at the first position is transformed in ester group), citric acid-2-ethyl ester (carboxyl group on a carbon atom at the second position is transformed in ester group). In the present invention, both of the citric acid ethylesters can be used. Further, a mixture of citric acid monoethylesters (transformations are made at the first and second positions), citric acid diethylesters (transformations are made at the first and second positions or the third and fourth positions), and citric acid triethylesters may be used. Particularly preferable is one or a mixture of monoethylester and diethylester. Further, the additional weight ratio of one of the citric acid or the citric acid ethylester to the TAC is preferably in the range of 10 ppm to 1000 ppm, particularly 50 ppm to 800 ppm, and especially 100 ppm to 600 ppm. The adding method of the acid compounds to the dope is described in detail in Japanese Patent Laid-Open Publication No.2002-304754, which is the research of the inventor of the present invention.

[Solution Casting Method]

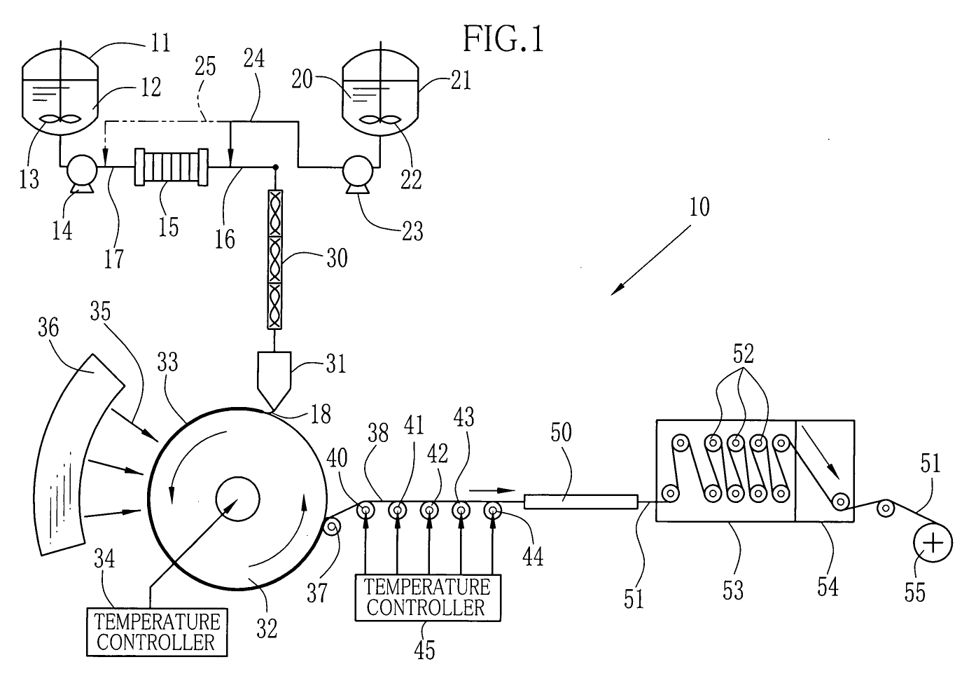

FIG. 1 is a schematic diagram of a film production line 10 as an embodiment of a solution casting method of the present invention. A mixing tank 11 contains a prepared dope 12 which is prepared in the above method. The prepared dope is stirred by a stirrer 13 which is rotated by a motor (not shown), so as to be uniform. The prepared dope 12 is fed by a feed pump 14 to a filtration device 15, in which impurities are removed. Then the prepared dope 12 is fed to an inline pipe 16. Further, an additional solvent 20 is contained in a mixing tank 21 and stirred by a stirrer 22. Further, the additional solvent 20 is fed through a pipe 24 to the inline pipe 16 by a feed pump 23.

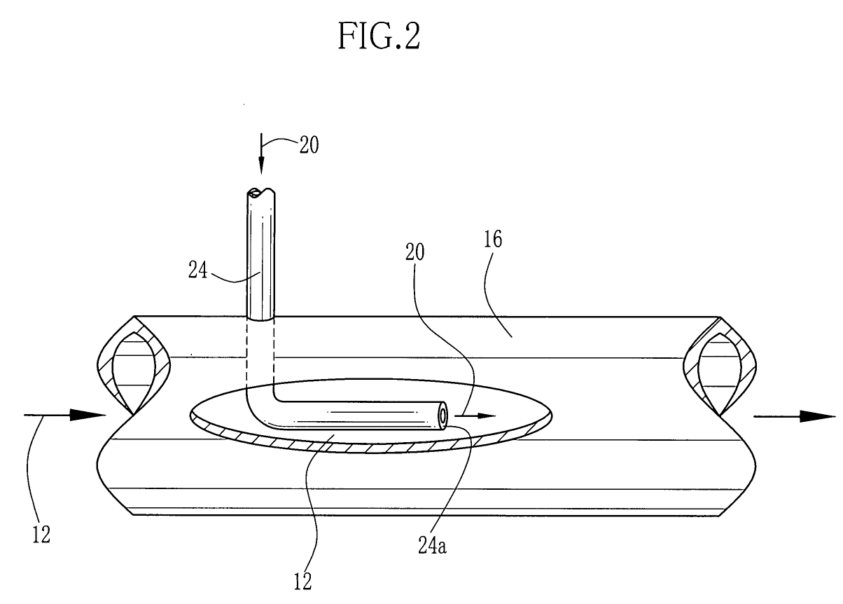

As shown in FIG. 2, an exit 24a of the pipe 24 is disposed in the prepared dope 12 flowing in the inline pipe 16. The additional solvent 20 is fed through the exit 24a from the pipe 24. When S1 (m/min) is a flow rate of the additional solvent 20 and S2 (m/min) is that of the prepared dope 12, a ratio (S1/S2) is preferably in the range of 1.0≦(S1/S2)≦1.5. Further, a shearing speed S′ of the prepared dope 12 is preferably at least 20(1/sec), particularly 30(1/sec), and especially 40(1/sec).

The additional solvent 20 is mixed to the prepare dope 12 such that a content of the poor solvent components in the dope may become larger. When chlorine organic solvent or non-chlorine organic solvent is used as a main solvent, the mixture solvent of the dope at the casting may contain contains the poor solvent components preferably in the range of 5 wt. % to 50 wt. %, particularly 10 wt. % to 45 wt. %, and especially 20 wt. % to 40 wt. %. When the poor solvent components are contained, the storage modulus of the casting film becomes higher. However, if the content of the poor solvent components in the mixture solvent is less than 5 wt. %, the effect thereof is not enough. Further, if the content of the poor solvent components to which the polymer is hardly dissolved is more than 50%, the polymer or the additives can precipitate from the dope. Note that the non-chlorine organic solvent can be used as the main solvent, and therefore the prevent invention is excellent in view of the environment conservation.

Necessary quantity of the additional solvent may be added to the prepared dope 12 at one time or several times. In the latter case, since the content of the poor solvent components in the dope increases stepwise, the solubility of the TAC is kept.

It is hard to dissolve the TAC to the mixture solvent containing the high concentration of the poor solvent components. However, in this embodiment the TAC is easily dissolved to the solvent with high content of the good solvent components, such that the prepared dope is obtained, and thereafter the additional solvent is added to the prepared dope. Thus the casting dope containing the high concentration dope can be prepared in short time. Further, as additional solvent, only one sort of the poor solvent components, a mixture solvent of the plural poor solvent components, or a mixture solvent of the poor solvent components and the good solvent components can be used. However, it is preferable to use the mixture solvent of the poor solvent components and the good solvent components. In this case, it is prevented to locally increase the content of the poor solvent components, and to locally decrease the solubility of the TAC.

The addition of the prepared dope 12 to the additional solvent 20 is preferably made in an inline method with use of the inline pipe 16. The inline method is excellent for shortening a time for producing plural sorts of the film in one film production line and changing the sorts of products, and a time for changing the addition rate of the additional solvent. The prepared dope 12 and the additional solvent 20 are mixed and stirred with use of a static mixer 30 to prepare a uniform casting dope 18. Note that the mixer used in the present invention is not restricted in the static mixer. Further, in the present invention, the additional solvent may be added to the prepared dope in a batch mixing method.

The addition of the additional solvent to the prepared dope 12 is made such that the percentage of the poor solvent contained in the additional solvent may be at most 20 wt. % to the solvent in the prepared dope 12. The polymer such as the TAC is more hardly dissolved to the poor solvent components than the good solvent components. If the poor solvent components are added too much, the dissolved polymer and additives would precipitate. Accordingly the concentration of the poor solvent components is controlled in the above range.

The position of mixing the additional solvent 20 is not restricted in the inline pipe 16 disposed between the filtration device 15 and the casting die 31. For example, the pipe 17 between the mixing tank 11 and the filtration device 15 may be an inline pipe to which a pipe 25 is connected.

The number of elements of the static mixer is not restricted especially. However, it is preferably from 20 to 80 in consideration with the experimental conditions, such as mixing abilities and the increase of a feeding pressure. The casting dope 18 is cast from the casting die 31 onto a rotary drum 32 to form a casting film 33. The casting is made such that a produced thin film after the dry may have a film thickness from 10 μm to 60 μm. Further, a width of the casting dope 18 is preferably at least 2000 mm, and particularly at least 1400 mm. The rotary drum 32 is driven by a driver (not shown) to endlessly rotate.

Preferably, a temperature controller 34 is connected to the rotary drum 32 for adjusting the surface temperature of the rotary drum 32. In the solution casting method of the present invention, the storage modulus of the casting film 33 is high to reduce the generation of the defective peeling. The storage modulus depends on the temperature, and exponentially increases in accordance with the temperature decrease in the casting film 33 in which the polymer is the TAC. Accordingly, the cooling of the rotary drum 32 easily increases the storage modulus without a special alteration of the prior instruments. The temperature of the rotary drum 32 is preferably at most −5° C., particularly at most −7° C., and especially at most −10° C.

In order to dry the casting film 33, it is preferable to provide a blow-dryer 36 for feeding a drying air 35 to dry the casting film 33. Although not restricted especially, the temperature of the drying air 35 is preferably less than that of the rotary drum 32 for dew condensation prevention. In order to prevent the liquefaction of the solvent in the dope, it is especially preferable that the drying air 35 blows, whose temperature is less than a dew point of the solvent.

In the film production, it is necessary to stably make the peeling at high speed. Accordingly, when the peeling of the casting film 33 from the rotary drum 32 is made, it is necessary to apply an adequate peeling force to the casting film 33, in accordance with an elastic modules of the casting film 33 at the peeling and a adhesion between the casting film 33 and the rotary drum 32. Further, when the elastic modules of the casting film 33 is smaller than the peeling stress, the casting film 33 is stretched in effect of the peeling stress to provide an optical anisotropy for the produced film of the TAC. In this case, the optical properties of the produced film become worse. When the storage modulus G′ of the casting film 33 at the peeling is at least 150 thousands Pa, the defective peeling is prevented. The storage modulus G′ is preferably at least 200 thousands Pa, and especially 300 thousands Pa.

The storage modulus G′ is a physical value depending on a temperature. In the present invention, the storage modulus G′ is determined as a value of the elastic modules of the casting film 33 at the temperature when the peeling is made. The storage modulus G′ can be regulated by adequately selecting some of following experimental conditions, namely, sorts and remaining quantity of the solvent in the casting film 33, sorts and remaining quantity of the poor solvent components compound, the temperature of the rotary drum 32, a peeling angle and feeding speed of the casting film 33, sorts and contents of the TAC, sorts and contents of the additives, and the like.

When being dried to progress the gelation, the casting film 33 has the self-supporting properties. When the storage modulus G′ is at least 150 thousands Pa, the casting film 33 is peeled as a gel-like film from the rotary drum 32 with support of a peeling roller 37. In the present invention, as described above, the TAC is easily dissolved to the solvent with high content of the good solvent components, such that the prepared dope is obtained, and thereafter the additional solvent is added to the prepared dope before the casting. In this case, not only the time for preparing the dope becomes shorter, but also the storage modulus G′ of the casting film 33 becomes higher. Thus the defective peeling is prevented.

In the present invention, the storage modulus G′ (or the storage modulus) is measured by a rheometer as a measuring device of steel cone having diameter at 4 cm/2°. The measuring mode is set to Oscillation Step/Temperature Ramp, and the temperature is changed at 2° C./min in the range of 40° C. to −10° C. Note that the temperature of the casting film as the sample is previously controlled to the above ranges before a start of the measurement. The measurement is made five times in the above measuring method, and the average value thereof is the storage modulus G′. Note that the accuracy of the measurement is in ±3%.

The gel-like film 38 is fed by many rollers 40-44 to a tenter type dryer (hereinafter, tenter dryer) 50. A section having these rollers 40-44 is named a connection part ( [symbol] ). Preferably, the rollers 40-44 are connected to the temperature controller 45 for controlling the temperatures thereof. For example, each roller 40-44 has a jacket into which a cooling medium is circularly fed. Further, the temperature of each roller 40-44 is preferably at most −5° C., particularly at most −7° C., and especially at most −10° C. Further, the temperature of each roller 40-44 is preferably kept constant such that the physical properties of the gel-like film 38 may not change. Note that when the gel-like film 38 is also cooled between the peeling roller 37 and the tenter dryer 50, the high storage modulus is kept and the defective feeding is prevented. Note that the number of the rollers between the peeling roller 37 and the tenter dryer 50 is five in this figure. In the present invention, however, the number is not restricted, and for example, preferably from 1 to 10.

In the tenter dryer 50, the gel-like film 38 is dried to become a film 51. In the tenter dryer 50, the temperature is kept from 50° C. to 140° C. The gel-like film 38 is fed for from 2 to 20 minutes under this condition in the tenter dryer 50, such that the drying is proceeded. If necessary, a drying air generator is provided in the tenter dryer 50 for drying moreover with the blowing air.

The optical properties of the TAC film depends on orientation of the TAC molecules in the film. The most effective method for regulating the arrangement of the TAC molecules is a method of stretching before the drying of the TAC film is complete. When the gel-like film is stretched in at least one of a transporting direction (or a casting direction of the solution casting) and a perpendicular direction thereto on the film, the orientation of the TAC molecules are controlled.

In the stretch, the TAC molecules sometimes has an orientation in the same direction, which often supplies optical anisotropies and a degradation of the optical properties for the produced film. These demerits becomes more remarkable in the thin film than the prior film having thickness about 80 μm. Accordingly, in the present invention, it is preferable that the stretch ratio of the film in the transporting direction is at most 110%. Thus the correction of the facial situation of the film, for example, the wrinkles which generates on a surface of the stretched gel-like film 38, is made, and the orientation of the TAC molecules are regulated such that the produced film may not be have defects of the optical properties. Note that the present invention is not restricted in that the stretching is made while the gel-like film is transported in the tenter dryer 50. Otherwise, when the casting film 33 is peeled as the gel-like film 38 from the rotary drum 32, the stretching is made. Further, while the gel-like film 38 is transported by the rollers 40-44, the stretching is made. When the total stretch ratio including those of the above stretching is preferably at most 110%, the optical properties of the produced film is good. Further the total stretch ratio is preferably at most 107%, and especially at most 105%.

The stretching of the gel-like film 38 is preferably made when the content of the remaining solvent is at least 10 wt %, particularly at least 30 wt. %, and especially at least 50 wt. %. The remaining solvent is the solvent used for preparing the dope, and contained in the gel-like film 38 in the performance of the stretching. The content of the remaining solvent CRS is determined in the following formula:
CRS=[Ws/Wf]×100(%)
In this formula, Ws is a weight of the solvent contained in the gel-like film, and Wf is a weight of the gel-like film containing the solvent. In order to know the weight of the gel-like film 38, a unit size of the gel-like film is sampled, and the weight of the sample is measured.

When the content of the remaining solvent is less than 10 wt. %, the drying of the gel-like film 38 proceeds too much. In this case, even if the stretching is made, it is difficult to regulate the arrangement of TAC molecules. Further the defects, such as the tearing, sometimes occur in the gel-like film 38.

The gel-like film 38 is dried and transported as the film 51 from the tenter dryer 50 to a drying chamber 53 in which many rollers are arranged. The film 51 is transported and dried with being contacting to rollers 52. Preferably the temperature in the drying chamber 53 is in the range of 90° C. to 145° C., and the drying time is in the range of 2 minutes to 30 minutes. However, they are not restricted in these ranges. Further, in a cooling chamber 54, the film 51 is preferably cooled to about a room temperature (about 25° C.). However, the temperature of the cooled film 51 is not restricted in it, and for example, may be decreased to about 60° C. Further, in the present invention, front and back edges of the film 51 may be cut of, and the knurling may be provided before the film 51 is wound. Note that the film production line 10 used for performing the solution casting method of the present invention is not restricted in FIG. 1.

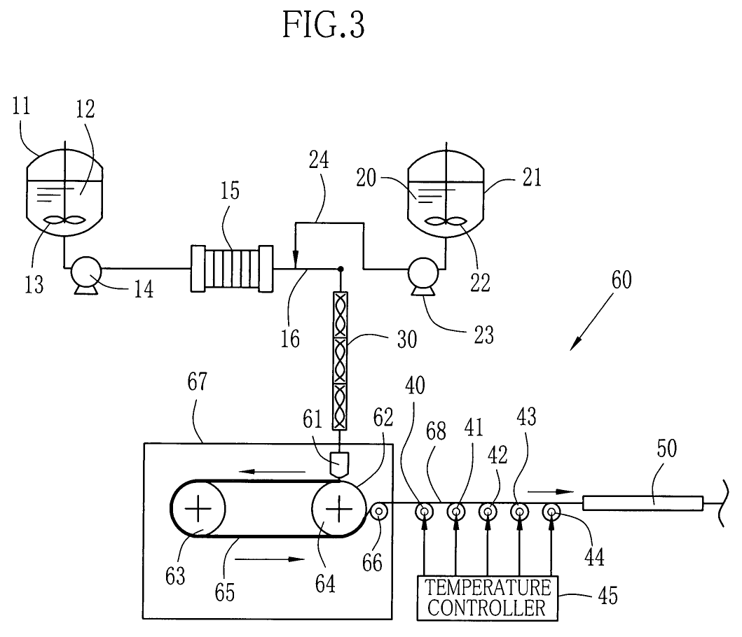

FIG. 3 illustrated a film production line 60 as another embodiment to which the solution casting method of the present invention is applied. Note that the same numbers are applied to the same members and devices as the film production line 10. After the mixing of the additional solvent 20, the stirring is made by the static mixer 30, such that the uniform casting dope may be obtained. Then the casting dope is cast on a belt 62 from a casting die 61. The belt 62 is endlessly moved in accordance with rotary rollers 63,64 which are rotated by a driver (not shown). After the storage modulus of a casting film 65 formed on the belt 62 becomes at least 150,000 Pa, preferably 200,000 Pa, and particularly at least 300,000 Pa, the casting film 65 is peeled as a gel-like film 68 with support of a peeling roller 66. Thereafter, the gel-like film 68 is transported by the rollers 40-44. Then after passing through the drying chamber and the cooling chamber, the film is wound.

Further, also in the present invention, in order to set the storage modulus G′ to a predetermined value, the content of the dope is not only adjusted but also the temperature of the casting belt 62 as the support is preferably at most −5° C., particularly at most −7° C., and especially at most −10° C. Note that a drying device and a cooling device may be provided in the casting chamber 67 adequately.

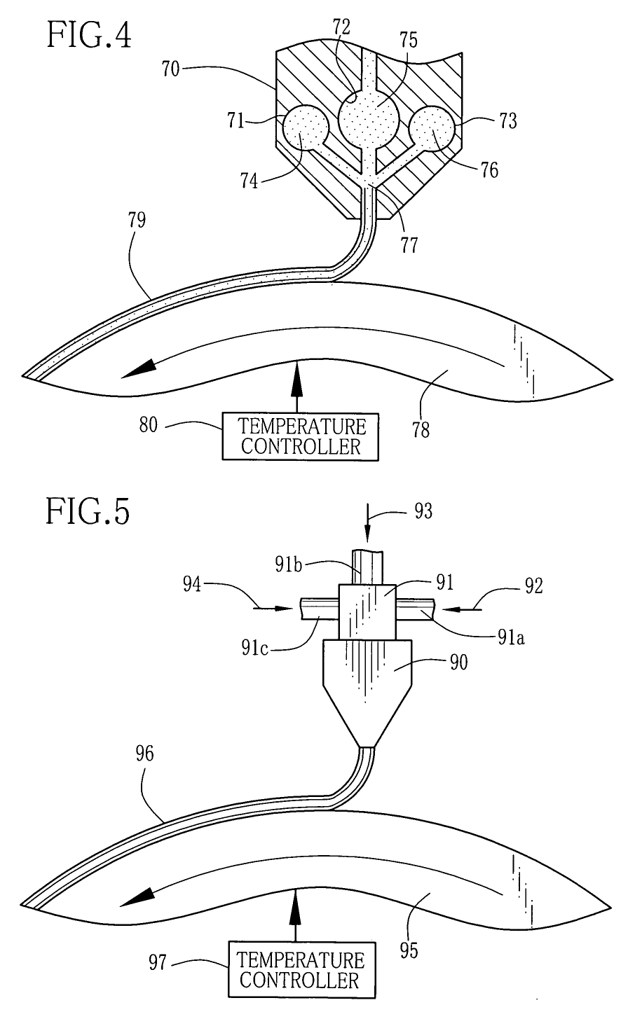

A co-casting method with a multi-manifold type casting die 70 will be explained in reference with FIG. 4. Dopes 74-76 are fed through feeding pipes (not shown) into manifolds 71-73 of the casting die 70. Note that at least one of the dopes 74-76 is a casting dope in which the content of the poor solvent components is higher than others. After the dopes 74-76 are joined into a feed path 77, the co-casting thereof onto a rotary drum 78 is made to form a casting film 79. Preferably, a temperature adjusting device 80 is provided for the rotary drum 78 so as to adjust the temperature. Thereafter, in a similar manner to the film production line 10 in FIG. 1, the casing film 79 having the self-supporting properties is peeled from the rotary drum 78, dried, stretched, cooled, and then wound as the film. Also in the present embodiment, since at least one of the dopes 74-76 are the casting dope, the casting film 79 just after formed easily has the storage modulus G′ of at least 150,000 Pa. Further, since the rotary drum 78 is cooled, the storage modulus G′ can be increased, and the occurrence of the defect 78 at the peeling is prevented.

Another embodiment of the co-casting method is explained in reference with FIG. 5. A feed block 91 is provided in an upstream side of the casting die 90.

Dopes 92-94 are fed from a feeding device (not shown) through feeding pipes 91a-91c into the feed block 91. Note that hat least one of the dopes 92-94 is a casting dope in which the content of the poor solvents is higher than others. After the dopes 92-94 are joined in the feed block 91, the co-casting thereof onto a rotary drum 95 is made to form a casting film 96. Preferably, a temperature adjusting device 97 is provided for the rotary drum 95 so as to adjust the temperature. In the present embodiment, at least one of the dopes 92-94 are the casting dope in which the content of the poor solvent is higher, and therefore the casting film 96 easily has the storage modulus G′ of at least 150,000 Pa. Further, since the rotary drum is cooled (for example at −5° C.), the storage modulus G′ can be increased, and the defect occurring at the peeling is prevented. The casing film 96 is peeled from the rotary drum 95, dried, stretched, cooled, and then wound as the film. note that in the present invention a belt can be used as the support instead of the rotary drum when the film production is made in the co-casting method (see, FIG. 3).

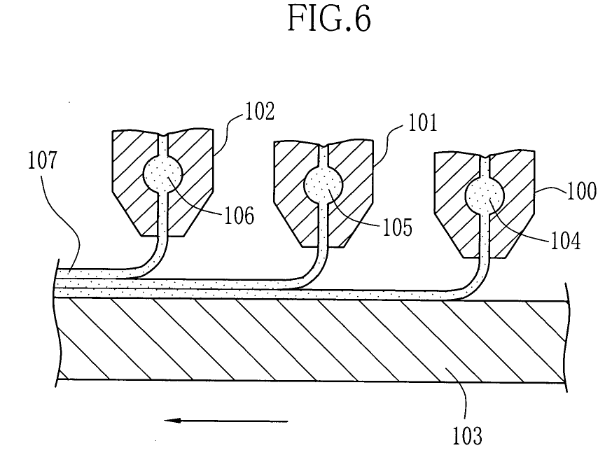

Still another embodiment of the solution casting method of the present invention is explained in reference with FIG. 6. The three casting dies 101-102 are disposed on a casting belt 103. Dopes 104-106 are respectively fed from a feeding device (not shown) to the dies 100-102. The dopes 104-106 are sequentially cast from the dies 100-102 onto the belt 103 in a sequential-casting method to form a casting film 107. At least one of the dopes 104-106 is the casting dope in which the content of the poor solvent is higher, and therefore the casting film 107 easily has the storage modulus G′ of at least 150,000 Pa. The casing film 107 is peeled from the rotary drum 103, dried, stretched, cooled, and then wound as the film (see, FIG. 3). Further, in the solution casting method of the present invention, the co-casting method and the sequential-casting method may be combined to perform the multi-layer casting.

[Film]

The film of the present invention may be produced in the above-described and other methods. The TAC film made of TAC as the polymer is, for example, used as a protective film for a polarizing filter. In the polarizing filter, a polarized film is a polyvinylalcohol film (PVA film) which has a polarizing functions and to which the dichroic materials are adsorbed, and sandwiched between the TAC film. The TAC film protects the PVA film, and prevents the sublimation of the iodine. Further, the TAC film is required to have a small optical anisotropy for improving a polarization degree of the polarized film. The optical anisotropy is judged from the largeness of a in-plain retardation (Re).

The in-plane retardation (Re) is measured by a Elipsometer (M-150, produced by Jasco Corporation) with use of a light of 580 nm wavelength. The formula is:
Re=(Nx−Ny)×d
Nx is a birefringence in the transporting direction of the film (or in the casting direction),
Ny is a birefringence in an direction which is on a film surface and perpendicular to the transporting direction,
d is a thickness (nm) of the film.
   The thickness d of the film is measured with a micrometer. In-plane retardation values is measured at 20 measuring points, and an average value thereof is used as the in-plane retardation (Re) of this embodiment.

In the present invention, the Re is preferably at most 10 nm, particularly at most 6.5 nm, and especially at most 3 nm. In the present invention, the film excellent in the optical properties, namely in the optical isotropy, can be obtained by regulating the storage modulus G′ or a stretching ratio in the film production. However, it is especially preferable to perform both of regulating the storage modulus G′ and the stretching rate. Note that the slow axis is preferable at most 10°, particularly at most 5°, and especially at most 3°.

When the polymer molecules are arranged well, the birefringence occurs in accordance with the orientation of the polymer molecules. In order to decrease the Re, it is necessary that the polymer molecules constructing the film are arranged in random. TAC has no strong bond such as double bound and the like, small number of the polarized group in one molecule, and no large functional group, such as phenyl group and the like. Therefore TAC has the high degree of arrangement freedom. Further, at a high substitution degree, the six hydroxide groups on an end of a cellobiose group are substituted for alkyl group at high degree of substitution. Accordingly, it is considered that the effects of the hydrogen bond of the hydroxide group is small and the regular arrangement of the molecules is prevented.

The hydroxyl groups (—OH) in one glucose unit of cellulose as a raw material of the TAC is substituted for acyl groups (—C—CO—R¹), and the degree of substitution is from 2.7 to 2.9. When the degree of substitution is larger than 2.9, the solubility of the TAC to the solvent becomes lower. When the degree of remaining hydroxyl groups in one glucose unit is from 0 to 0.1, the hydrogen bond is not formed, or the hydrogen bond is formed not so as to reduces the degree of freedom of the TAC molecules arrangement. Further, the acylation degree of the hydroxyl group at 6^{th} position in one glucose unit (—⁶CH₂—OH) is from 0.8 to 0.97. Further, instead of acetylation with a group having methyl group (—CH₃) as the alkylgroup R¹, the acylation may be made by substitution for the alkyl group having at least two carbon atoms, so as to regulate the arrangement of the TAC molecule. The carbon atom at 6^{th} position in one glucose unit is on a side chain while the cellulose is regarded as the main chain. The large functional group may be substituted on the side chain so as to reduce the intermolecular cohesive force, or the substitution for functional groups having strong intermolecular cohesive force is made. Thus the arrangement of the TAC molecules are regulated.

Further, in the present invention, in order to regulate the arrangement of the TAC molecules, when the casting film and the gel-like film are dried, the poor solvent (mainly alcohols) is contained therein. Accordingly, the hydroxyl group in the TAC molecule easily forms the hydrogen bond to the hydroxyl group in the alcohol, which might reduce the forming the hydrogen bonds between the TAC molecules and the orientation of the TAC molecules.

The situation of arrangement of the molecules in the TAC film can be known from a transmittance speed of the sonic wave, and the optical properties (mainly optical isotropies) can be estimated. Thus it is judged whether the produced film is adequate for the optical film such as the protective film for the polarizing filter.

In order to measure the transmittance speed of the sonic wave, the two vibrators (a wave transmitting oscillator, a wave receiving oscillator) are confronted with a distance L1 of 150 mm, and the wave generation vibrator generate a longitudinal wave. The time T (μs) for generating the longitudinal wave by the wave generation vibrator is measured after that of the wave receiving oscillator. Note that in the present invention, the measuring device is SST-110 (Nomura Shoji KK). The sampled film is disposed in an atmosphere of 25% RH at 25° C. for two hours so as to keep the temperature and the moisture. The transmittance speed C is calculated from the following formula:
C(km/s)=L1(km)/T(s)
Note that the measurement of the transmittance speed is made five times while the positions of two oscillators are changed every time. The average of the five measured values is found as the transmittance speed C. When there are molecules arranged in random, the travel of the wave is disturbed, and the transmittance speed becomes lower. Accordingly it is judged that the orientation of the molecular is good when the transmittance speed C is large.

In the cellulose acylate film according to the present invention, the transmittance speed C1 of the sonic wave in the transporting direction of the film (or the casting direction) is at most 2.65 km/s, and the transmittance speed C2 in a widthwise direction of the film is at least 2.20 km/s. In the solution casting method, each molecule easily has an orientation in the transporting direction of the film. Accordingly, the ratio (C1/C2) of the transmittance speed between the transporting direction and the widthwise direction is preferably in the range of 0.8<(C1/C2)<1.5, and especially 1.0<(C1/C2)≦1.3.

It is judged from the infrared absorption spectra whether the optical properties of the cellulose acylate film of the present invention are good. In the measurement of the infrared spectra, a polarized light (hereinafter I(A)) in the transporting direction (or the casting direction) and a polarized light (hereinafter I(B)) in the perpendicular direction are used, and a absorbance of each polarized light is measured at the wave number of 1050 cm⁻¹. The infrared spectrum is measured with MAGNA-R 560 (produced by Niclet Co. Ltd.), and the measuring method may be a transmission method or an ATR method (Attenuated Total Reflectance Method) in the present invention. However, the measuring method is not restricted in it. In the measurement of this embodiment, a prism (KRS-5, 45°, thickness 2 mm) and attachment (MODEL ATR-117, produced S.T. JAPAN Inc.) are used. As the measuring conditions, the accumulation number is 50, and a resolution is 4 cm⁻¹.

In the present invention, the cause of the absorbance of the 1050 cm⁻¹ wave would be a stretching vibration of C—O bond in —C—O—C— of a 6-membered ring in cellobiose group. From this point, the arrangement of the main chain can be estimated. The absorbance of the 1050 cm⁻¹ wave with use of the polarized light I(A) is A₁₀₅₀(I(A)) and the absorbance of the 1050 cm⁻¹ wave with use of the polarized light I(B) is A₁₀₅₀(I(B)). It is estimated that the molecules, especially the main chains, are arranged in random in the transporting direction, when the following condition is satisfied:
A₁₀₅₀(I(A))/A₁₀₅₀(I(B))≦1.2 (1)
In this case, the film having a low Re value is obtained.

The cause of the absorbance of the 1760 cm⁻¹ wave would be a stretching vibration of C═O bond in the acyl group (—O—(C═O)—R¹). When the absorption of the 1760 cm⁻¹ wave, the arrangement of the branched chain can be estimated. The measuring method is the same as that in which the 1050 cm⁻¹ wave is used.
A₁₇₆₀(I(A))/A₁₇₆₀(I(B))≦1.2 (2)
When both formulae (1) and (2) are satisfied, the molecules are randomly oriented.

The film of the present invention is defined by the formulae (1)&(2) and a parameter of one of the transmittance speeds C1,C2 of the sonic wave. Then the parameters are satisfied, the film having a preferably Re value can be obtained. Usually, since a single crystal of the polymer is hardly obtained, the structure thereof (arrangement of the molecules) is not easily determined. Accordingly, in the present invention, the absorbance peculiar to the TAC molecules in an infrared region (1050 cm⁻¹ and/or 1760 cm⁻¹) and the transmittance speeds C1,C2 of the sonic wave in the transporting direction and the widthwise direction are measured. Thus the arrangement of the TAC molecules is easily determined. When these parameters are satisfied, it is estimated that the TAC molecules are arranged in random in the film, and that the film is excellent in the optical isotropy.

The film of the present invention may satisfy at least one of the factors of the formula (1), the formulae (1)-(2), and the transmittance speeds C1,C2. In the film, when the parameter is satisfied, the molecules are arranged in random and the optical isotropy is excellent.

[Products with Use of Film]

The film of the present invention, especially the TAC film, is preferably used as an optical film, such as the protective film in the polarizing filter, the optical compensation film provided with a optical compensation sheet on the TAC film, and an antireflection film in which antiglare layers are formed on the film. Further, the film may be used in a liquid crystal display constructed of the polarizing filter and the optical compensation film.

In followings, the examples of the present invention are explained in detail, and the embodiment of the present invention is not restricted in the examples.

### EXAMPLE 1

(Preparation for Dope A)

A mixture solvent was prepared so as to be a chloride type organic solvent whose composition was dichloromethane (85 wt. %), methanol (12 wt. %), butanol (3 wt. %). The raw materials of the cellulose triacetate (TAC) were wood pulp and cotton linter in ratio of 3:1. In the TAC obtained from the wood pulp, the acetylation degree was 60.9%, the degree of polymerization was 300 and the diameter was from 2 mm to 3 mm. In the cotton linter, the acetylation degree was 60.9%, the degree of polymerization was 360, and the diameter was from 2 mm to 3 mm. The plasticizer was a mixture of TPP and BDP in weight ratio of 3:1, and the UV absorbing agent was benzotriazol type compounds. They were mixed such that the mixture ratio may be (mixture solvent):(polymer):(plasticizer):(UV-absorbing agent)=(63 wt. %):(23 wt. %):(12 wt. %):(2 wt. %). To the TAC is added citric acid ethylester in which citric acid monoethyl and citric acid diethyl were mixed in the weight ratio of 1:3, and the quantity of the added citric acid ester was 600 ppm to the weight of the TAC. The mixture was stirred for one hour with keeping the temperature to 35° C., and thereafter naturally cooled to the room temperature so as to obtain a solution. The solution was filtrated with a filter whose averaged porous diameter was 50 μm. In a lazer beam scattering method, it was ascertained that there were no impurities and aggregation in the solution, and thereafter 0.13 wt. % silica particles (averaged diameter was 0.2 μm) were mixed to the 100 wt. % of the solution, and dispersed to a dope A.

(Preparation for Dope B)

A mixture solvent was prepared so as to be a chloride type organic solvent whose composition was methyl acetate (74 wt. %), acetone (7 wt. %), methanol (5 wt. %), ethanol (10 wt. %), butanol (4 wt. %). The raw material of the cellulose triacetate (TAC) was wood pulp. In the TAC obtained from the wood pulp, the acetylation percentage was 60.1%, the degree of polymerization was 300, the degree of acetylation at 6^{th} position was 0.9, and the diameter was from 2 mm to 3 mm. The additives were the same as in the dope A. The preparation method of the dope was the same as the dope A, and it was ascertained that there were no impurities and aggregation in the solution, and thereafter 0.13 wt. % silica particles (averaged diameter was 0.2 μm) were mixed to the 100 wt. % of the solution, and dispersed to a dope B.

In Example 1, the examinations of a relation of the stretch ratio and the optical properties were made as Examinations 1-3 of the present invention and Examinations 4-5 of comparisons. The conditions of the examinations were explained in detail in Examination 1, and the same explanations as Examination 1 are omitted in Examinations 2-5.

In Examination 1, the film was produced in the film production line 10 in FIG. 1. Note that the static mixer 30 of the film production line 10 was removed, and the filtration device 15 and the casting die 31 were directly connected with the pipe. The rotary drum 32 was processed by hard chromium plating, and a mirror finish thereof was made such that the surface roughness may be Ra=0.02 μm. Further, the surface temperature of the rotary drum 32 was controlled to −7° C. by the temperature controller 34.

The dope A was contained in the mixing tank 11, and the temperature of the dope A was kept to 35° C. with a temperature controlling apparatus (not shown). The dope A was cast on the rotary drum 32 to form the casting film 33, such that the film 51 after dried may have the thickness of 40 μm. Thereafter, the casting film 33 was peeled as the gel-like film 38 with support of the peeling roller 37. Then the gel-like film was transported to a tenter dryer 50 by the rollers 40-44 whose temperature was controlled to −7° C. In the tenter dryer 50, the drying was made at 120° C. for 3 minutes. Note that the stretching was made such that the gel-like film becomes 2% longer in the widthwise direction (or casting direction). Thereafter, the drying was made in the drying chamber 53 at 140° C. for 10 minutes. The film 51 was wound by a winding apparatus 55. The Re value was measured in the above method, and it was 5 nm.

In order to make a stretch in the transporting direction, when the transporting speed of the rotary drum 32 is 100%, the transporting speeds of the peeling rollers 37, 40-44 and the tenter dryer were respectively adjusted to 101%, 102%, 103%, 104%, 105%, 106%, and 107%.

The marking on the gel-like film was made at a first point as the peeling point from the rotary drum 32 and at second point which is lm downstream from the peeling point. Then before wound by the winding apparatus 55, a length between the first and second points of the film 51 for calculating the stretch ratio in the transporting direction. the stretch ratio was 107% in Example 1, and the result teaches that the above described adjusting method of the transporting speed was adequate.

In Experiment 2, the adjustment of the transporting speed was made such that the stretch ratio in the transporting direction was 104%. Other conditions were the same as Experiment 1. In Experiment 3, the dope B was used instead of the dope A, and other conditions were the same as in Experiment 2. Further, in Experiment 4, the transporting speed was adjusted such that the stretch ratio in the transporting direction was 113%, and other conditions were the same as Experiment 1. the components of the solvent, the film thickness, the stretch ratio in the transporting direction, and the Re value are shown in Table 1.

TABLE 1

| | | Composition of Solvent | | | | | | | | |
|---|---|---|---|---|---|---|---|---|---|---|
| | Dope | DCM | MeOH | EtOH | BuOH | MeAc | Ac | FT (μm) | SR (%) | Re (nm) |
| Exp. 1 | A | 85 | 12 | — | 3 | — | — | 40 | 107 | 5 |
| Exp. 2 | A | 85 | 12 | — | 3 | — | — | 40 | 104 | 3 |
| Exp. 3 | B | — | 5 | 10 | 4 | 74 | 7 | 40 | 104 | 3 |
| Exp. 4 | A | 85 | 12 | — | 3 | — | — | 40 | 113 | 15 |
| Exp. 5 | A | 85 | 12 | — | 3 | — | — | 80 | 113 | 3 |

DCH: dichloromethane
MeOH: methanol
EtOH: ethanol
BuOH: butanol
MeAc: methylacetate
Ac: acetone
FT: film thickness
SR: stretch ratio in transporting direction
Re: Re value

Table 1 teaches that when the film thickness is small, the Re value increases extremely in accordance with the increase of the stretch ratio. The reason therefor would be that the TAC molecules are oriented in the same direction in the stretching to increase the optical anisotropy. Accordingly, when the thin film is produced, it is preferable to abstain the stretching as much as possible, in order to obtain the film excellent in optical properties. Note that, in Experiment 3, the stretch ratio was 100% when the film was produced from the dope in which non-chlorine type organic solvent was used. In this case, the Re became 3 nm.

### EXAMPLE 2

In Example 2, experiments for a relation between the storage modulus G′ of the casting film to the optical properties were made as Experiments 6-8 of the present invention and Experiments 9-10 of the comparisons. The experimental conditions of Experiment 6 are explained in detail, and the same explanations of Experiments 7-10 as Experiment 6 are omitted.

In Experiment 6, the temperature T of the rotary drum 32 was −10° C., and other conditions were the same as in Experiment 1. The Re value of the film was measured in the above described method, and it was 4 nm. The storage modulus G′ was measured too. A Rheometer measurement of the prepared dope 12 was made and the storage modulus G′ was calculated from the measured data. the storage modulus G′ of the gel-like film 38 was 220 thousands Pa at the peeling.

In Experiment 7, the temperature T of the rotary drum 32 was −15° C., and other conditions were the same as in Experiment 6. In Experiment 8, the dope B was used instead of the dope A, the temperature T of the rotary drum 32 was −30° C., and other conditions were the same as in Experiment 6 Further, in Experiment 9, the temperature T of the rotary drum 32 was −3° C., and other conditions were the same as Experiment 6. In Experiment 10, the casting onto the rotary drum 32 whose temperature was −3° C. was made such that the film thickness after the drying was 80 μm. The sorts of the dope, the film thickness, the storage modulus G′ and the Re value are shown in Table 2.

TABLE 2

| | Dope | FT(μm) | T(° C.) | G′(Pa) | Re(nm) |
|---|---|---|---|---|---|
| Exp. 6 | A | 40 | −10 | 220,000 | 4 |
| Exp. 7 | A | 40 | −15 | 310,000 | 2 |
| Exp. 8 | B | 40 | −30 | 150,000 | 3 |
| Exp. 9 | A | 40 | −3 | 105,000 | 14 |
| Exp. 10 | A | 80 | −3 | 105,000 | 3 |

Table 2 teaches that when the film thickness is small, the Re value increases extremely in accordance with the decrease of storage modulus G′. The reason therefor is that the film is stretched in effect of peeling stress occurring in peeling the casting film 33 if the storage modulus G′ is small. In this case, the effect of the stretching easily remains in the film, and the TAC molecules are oriented in the same direction. Accordingly, the optical anisotropy would become larger. Further this phenomena is remarkable from the results of Experiments 6-8 and 10 when the thin film is produced. Therefore it is preferable that the temperature of the rotary drum 32 as the support is at most −5° C. such that the storage modulus G′ is at least 150 thousands Pa.

### EXAMPLE 3

In Example 3, experiments for a relation and a stretch ratio of the storage modulus of the casting film to the optical properties were made as Experiments 11-13 of the present invention and Experiments 14-15 of the comparisons. The experimental conditions of Experiment 11 are explained in detail, and the same explanations of Experiments 12-15 as Experiment 11 are omitted.

In Experiment 11, the temperature T of the rotary drum 32 was −15° C., and the transporting speed was adjusted such that the stretch ratio in the transporting direction was 104%. Other conditions were the same as in Experiment 1. The storage modulus G′ was 310 thousands Pa, and the Re value of the film was 2 nm. In Experiment 12, the dope B was used instead of the dope A, the temperature T of the rotary drum 32 was −30° C., and other conditions were the same as in Experiment 11. In Experiment 13, the temperature T of the rotary drum 32 was −10° C., and other conditions were the same as in Experiment 11. In Experiment 14, the temperature T of the rotary drum 32 was −3° C., the transporting speed was adjusted such that the stretch ratio in the transporting direction was 113%, and other conditions were the same as Experiment 11. In Experiment 15, the casting onto the rotary drum 32 whose temperature was −3° C. was made such that the film thickness after the drying was 80 μm, the transporting speed was adjusted such that the stretch ratio in the transporting direction was 113%, and other conditions were the same as Experiment 11.

The sorts of the dope, the film thickness, the storage modulus G′, the stretch ratio in the transporting direction, and the Re value are shown in Table 3. Further, the estimation of the physical properties are:
A when the Re value was at most 3 nm,
B when the Re value was at most 10 nm, and

C when the Re value was more than 10 nm.

TABLE 3

| | Dope | FT(μm) | SR(%) | T(° C.) | G′(Pa) | Re(nm) | Est. |
|---|---|---|---|---|---|---|---|
| Exp. 11 | A | 40 | 104 | −10 | 310,000 | 2 | A |
| Exp. 12 | B | 40 | 104 | −30 | 150,000 | 3 | A |
| Exp. 13 | A | 40 | 104 | −10 | 220,000 | 4 | B |
| Exp. 14 | A | 40 | 113 | −3 | 105,000 | 15 | C |
| Exp. 15 | A | 80 | 113 | −3 | 105,000 | 3 | A |

Table 3 teaches that when the film thickness is small, the Re value increases in accordance with the decrease of storage modulus G′ and the increase of the stretch ratio. The reason therefor is that the film is stretched in effect of peeling stress occurring in peeling the casting film 33 if the storage modulus G′ is small. In this case, the effect of the stretching easily remains in the film, and when the stretch ratio is increased in the Experiment 14, the effect for orienting the TAC molecules in the same direction becomes large. Accordingly, the Re value would become larger. From the results of Experiments 11-13, the thin film having excellent optical properties can be produced when the storage modulus G′ is at least 150 thousands pa and the stretch ratio is at most 110%.

### EXAMPLE 4

In Example 4, experiments for a relation between the temperature of the rotary drum as the substrate and the storage modulus of the casting film to the optical properties were made.

In Experiment 16, the temperature T of the rotary drum 32 was −15° C., and other conditions were the same as in Experiment 1. The storage modulus G′ was 310 thousands Pa, and the Re value of the film was 2 nm. Therefore the film having the extremely excellent optical properties was obtained. In Experiment 17, the temperature T of the rotary drum 32 was −10° C., and other conditions were the same as in Experiment 16. In Experiment 18, the dope B was used instead of the dope A, the temperature T of the rotary drum 32 was −30° C., and other conditions were the same as in Experiment 16. In Experiment 19 as a comparison, the temperature T of the rotary drum 32 was −3° C., and other conditions were the same as Experiment 16. In Experiment 20, the casting onto the rotary drum at −3° C. was made such that the film thickness after the drying was 80 μm, and other conditions were the same as Experiment 16.

TABLE 4

| | Dope | FT(μm) | T(° C.) | G′(Pa) | Re(nm) |
|---|---|---|---|---|---|
| Exp. 16 | A | 40 | −15 | 310,000 | 2 |
| Exp. 17 | A | 40 | −10 | 220,000 | 4 |
| Exp. 18 | B | 40 | −30 | 150,000 | 3 |
| Exp. 19 | A | 40 | −3 | 105,000 | 15 |
| Exp. 20 | A | 80 | −3 | 105,000 | 3 |

Table 4 teaches that the storage modules G′ of the casting film 33 depends on the temperature. Accordingly, when the temperature of the rotary drum 32 as the support is adjusted to cool the casting film 33, the storage modulus G′ is increased. Thus the peeling stress for peeling the casting film 33 from the rotary drum 32 becomes smaller, and the stretching is made at the peeling.

### EXAMPLE 5

In Example 5, experiments for a relation between a remaining solvent in the gel-like film 38 and the stretch were made as Experiments 21-23 of the present invention and Experiments 24-25 of the comparisons. The experimental conditions of Experiment 21 are explained in detail, and the same explanations of Experiments 22-25 as Experiment 21 are omitted.

In Experiment 22, the same film production line was used as Experiment 1. The dope A was contained in the mixing tank 11, and the temperature of the dope A was kept to 35° C. with a temperature controlling apparatus (not shown). The dope A was cast on the rotary drum 32 to form the casting film 33, such that the film 51 after dried may have the thickness of 40 μm. Thereafter, the casting film 33 was peeled as the gel-like film 38 with support of the peeling roller 37. Thereby the content of the remaining solvent in the casting film 33 (or the gel-like film 38) was 60 wt. %. The measuring method of the content of the remaining solvent will be explained in following.

Then the gel-like film 38 was transported to the tenter dryer 50 by the rollers 40-44 whose temperature was controlled to −7° C. In the tenter dryer 50, the drying was made at 120° C. for 3 minutes. The transporting speed was adjusted such that the stretch ratio in the transporting direction was 104%. Thereafter, the drying was made in the drying chamber 53 at 140° C. for 10 minutes. The film 51 was wound by the winding apparatus 55. The Re value was measured in the above method, and it was 3 nm.

(Content of Remaining Solvent)

In the present invention, the content of the remaining solvent is a percentage of the remaining solvent in the film (including the casting film and the gel-like film). It is hard to directly measure the content of the solvent contained in the film. Accordingly, a part of the film was cut off as a sample, and the weight Wf of the sample was measured. Then the sample was heated to evaporate and remove the remaining solvent from the part. Thereby the temperature is preferably set to the value at which the remaining solvent can be evaporated at most. However, when the temperature is too high, the polymer is decomposed to evaporate, and an oligomer and the like contained in the raw materials may be evaporated. In this case, the content of the remaining solvent cannot strictly calculated. Accordingly, the measurement is made under the low pressure.

In this experiments in which TAC was used as the polymer, the part of the film was cut off to size 50 mm×100 mm, and the weight of the film is Wf. When the film is contained in the vessel and heated at 120° C. for 90 minutes, it can be regarded that all of the remaining solvent evaporated. The sample after the evaporation is called a dried sample, and the weight thereof is W0. In this case, in the sample of the film contains the solvent of (Wf-W0) weight. The weight of the solvent is Ws. In this case, the content of the remaining solvent can be calculated in the following formula:
Content of Remaining Solvent=(Ws/Wf)×100(%)

In Experiment 22, the transporting speed was adjusted such that the stretch ratio in the transporting direction was 107%, and other conditions were the same as in Experiment 21. In Experiment 23, the dope B was used instead of the dope A, the transporting speed was adjusted such that the stretch ratio in the transporting direction was 113%, and other conditions were the same as Experiment 21. In Experiment 25 the casting onto the rotary drum was made such that the film thickness after the drying was 80 μm, the transporting speed was adjusted such that the stretch ratio in the transporting direction was 113%, and other conditions were the same as Experiment 21.

TABLE 5

| | Dope | FT(μm) | SR(%) | Content(wt. %) | Re(nm) |
|---|---|---|---|---|---|
| Exp. 21 | A | 40 | 104 | 60 | 2 |
| Exp. 22 | A | 40 | 107 | 60 | 4 |
| Exp. 23 | B | 40 | 102 | 70 | 3 |
| Exp. 24 | A | 40 | 113 | 60 | 15 |
| Exp. 25 | A | 80 | 113 | 70 | 3 |

### EXAMPLE 6

In Example 6, experiments in which the composition of the solvent for preparing the dope was changed were made as Experiments 26-27. In Experiment 26, the composition was (dichloromethane):(methanol):(n-butanol)=(85 wt. %):(12 wt. %):(3 wt. %).

In Experiment 27, the composition was (dichloromethane):(methanol):(n-butanol)=(60 wt. %):(28 wt. %):(12 wt. %). Note that the period for preparing the dope was twice larger in Experiment 27 than Experiment 26.

TABLE 6

| | Composition of Solvent | | | Cb | FT | G′ | Re |
|---|---|---|---|---|---|---|---|
| | DCM | MeOH | n-BuOH | (wt. %) | (μm) | (Pa) | (nm) |
| Exp. 26 | 85 | 12 | 3 | 15 | 40 | 220,000 | 4 |
| Exp. 27 | 60 | 28 | 12 | 40 | 40 | 320,000 | 2 |

Cb: concentration of poor solvent components

In Experiment 27 in which the content of-the poor solvent components is high, since the storage modulus was 320,000 and large, the obtained film was excellent in the optical properties such as the Re value of 2 nm. However, as the concentration of the poor solvent components was large, the time for preparing the dope was twice as large as in Experiment 26. Accordingly, when the film production line 10 of the present invention is used and the concentration of the poor solvent components is large, the storage modulus G′ of the gel-like film 38 formed from the casting dope is increased. In the gel-like film 38 whose storage modulus G′ is large, the increase of the optical properties is prevented in the stretching. When the film is produced in this manner, the dope is smoothly prepared and the producing speed of the film is improved.

### EXAMPLE 7

In Example 7, experiments of the dope preparing method was made, in which the poor solvent components was added to the prepared dope. An in-plane retardation (Re), wave transmittance speed, and infrared absorbance spectrum of a film from the prepared dope were measured. The experimental conditions were explained in detail in Experiment 28, and the same explanations of Experiments 29-33 as Experiment 28 are omitted. The added solvent, composition of the solvent in the dope are shown in Table 7, the condition of adding and the temperature of the rotary drum and the like are shown in Table 8, the results of the measurement of the transmittance speed of the sonic wave and the infrared absorbing spectrum are shown in Table 9.

In Experiment 28, the film was produced in the film production line 10 of FIG. 1. Note that the additional solvent 20 could be fed, and the static mixer 30 was connected. The prepared dope was the dope A. The dope A was contained in the mixing tank 11, and the temperature of the dope A was kept to 35° C. with a temperature controlling apparatus (not shown). Further, as the additional solvent 20, a mixture solvent of methanol and butanol (mixing ratio was 1:1) was used, and added such that the percentage of the additional solvent might be 5 wt. % to the solvent of the prepared dope. The additional solvent 20 was fed through the inline pipe 16 by the feed pump 23, and the mixture is mixed to be uniform by the static mixer 30 (number of elements were 48). The conditions of adding were inline adding (adding method 1). A flow ratio of the flow speed S1 (m/min) of the additional solvent 20 to the flow speed of the prepared dope 12 was 1.2. The sharing speed of the prepared dope 12 was 30 (1/sec). Thereafter, the dope was cast on the rotary drum 32 to form the casting film 33, such that the film 51 after dried may have the thickness of 40 μm. The rotary drum 32 was processed by hard chromium coating, and the surface roughness Ra was Ra=0.02 μm. The components of the solvent in the casting dope was (dichloromethane):(methanol):(butanol)=(81 wt. %):(14 wt. %):(5 wt. %). In this case, the percentage of the methanol and butanol as the poor solvent components was 19 wt. %. The casting film 33 was formed from the casting dope 18 and the drying air 35 at 40° C. blew at 5 m/min to proceed the drying. Thereafter, the casting film 33 was peeled as the gel-like film 38 with support of the peeling roller 37. Thereby the storage modulus G′ of the casting film 33 (or the gel-like film 38) was 250,000 Pa and the content of the remaining solvent was 70 wt. %. Then the gel-like film was transported to the tenter dryer 50 by the rollers 40-44 whose temperature was controlled to −7° C. The rotational speed of the rollers 40-44 were controlled such that the stretch ratio of the transporting direction was 104%. In the tenter dryer 50, the drying was made at 120° C. for 3 minutes. Thereafter, the drying was made in the drying chamber 53 at 140° C. for 10 minutes. The film 51 was wound by the winding apparatus 55. The Re value was 2.5 nm.

In Experiment 29, the additional solvent 20 was the mixture solvent of dichloromethane and methanol as the two poor solvents, in the ratio of (dichloromethane):(methanol)=1:1. The flow ratio was 1.1 and the mixture solvent and the prepared dope were mixed with the static mixer (number of elements were 48) to the uniform casting dope 18. The concentration of the poor solvent components (methanol and butanol) in the casting dope 18 was 19 wt. %. The casting dope 18 was cast on the rotary drum 32 whose temperature was controlled to −15° C. When the casting film 33 was peeled, the storage modulus of the casting film 33 (or the gel-like film 38) was 250,000 Pa and the content of the remaining solvent was 70 wt. %. Other conditions were the same as Experiment 28. The Re value of the obtained film 51 was 2.5 nm.

In Experiment 30, the additional solvent 20 was methanol (poor solvent), and added such that the percentage of the poor solvent (or the additional solvent in this case) to be added might be 10 wt. % to the solvent contained in the prepared dope. The flow ratio was 1.3 and the mixture solvent and the prepared dope were mixed with the static mixer (number of elements were 48) to the uniform casting dope 18. The concentration of the poor solvent components (methanol and butanol) in the casting dope 18 was 23 wt. %. The casting dope 18 was cast on the rotary drum 32 whose temperature was controlled to −7° C. When the casting film 33 was peeled, the storage modulus of the casting film 33 (or the gel-like film 38) was 350,000 Pa and the content of the remaining solvent was 70 wt. %. Other conditions were the same as Experiment 28. The Re value of the obtained film 51 was 2 nm.

In Experiment 31, the additional solvent 20 was butanol (poor solvent), and added such that the percentage of the poor solvent (or the additional solvent in this case) to be added might be 5 wt. % to the solvent contained in the prepared dope. The flow ratio was 1.5 and the mixture solvent and the prepared dope were mixed with the static mixer (number of elements were 48) to the uniform casting dope 18. The concentration of the poor solvent components (methanol and butanol) in the casting dope 18 was 19 wt. %. The casting dope 18 was cast on the rotary drum 32 whose temperature was controlled to −30° C. When the casting film 33 was peeled, the storage modulus G′ of the casting film 33 (or the gel-like film 38) was 250,000 Pa and the content of the remaining solvent was 70 wt. %. The rotation speed of the rollers 40-44 was adjusted such that the starch rate in the transporting direction may be 102%. Other conditions were the same as Experiment 28. The Re value of the obtained film 51 was 2.5 nm.

In Experiment 32, the additional solvent 20 was methanol. The prepared dope 12 of 100 kg and additional solvent 20 of 20 kg were mixed in a batch method such that the concentration of the poor solvent (or the additive solvent in this case) might be 15 wt. % to the solvent contained in the prepared dope. In the mixing, the prepared dope 12 and the additional solvent 20 were sequentially supplied into the mixing tank, and the mixture was stirred by maxblend blades at 50 rpm of the rotational speed for 30 minutes. The stirring was made in a room temperature, and the temperature was not controlled. During the stirring, the dope solidified and could not be used for producing the film.

In Experiment 33, the dope A was used as the casting dope 18. The rotation speeds of the rollers 40-44 were adjusted such that the starch rate in the transporting direction may be 113%. Other conditions were the same as Experiment 28. When the casting film 33 was peeled, the storage modulus G′ of the casting film 33 was 150,000 Pa and the content of the remaining solvent was 70 wt. %. The Re value of the obtained film 51 was 10 nm.

TABLE 7

| | Additional | | | | |
|---|---|---|---|---|---|
| | solvent | | | | |
| | (Composition) | Composition of Solvent | | | |
| | 1^{st} PSC wt. % | DCM | MeOH | BuOH | 2^{nd} PSC wt. % |
| Exp. 28 | methanol/butanol | 81 | 14 | 5 | 19 |
| | (1:1) | | | | |
| | 5 wt. % | | | | |
| Exp. 29 | dichloromethane/ | 81 | 16 | 3 | 19 |
| | butanol | | | | |
| | (1:1) | | | | |
| | 10 wt. % | | | | |
| Exp. 30 | methanol | 77 | 20 | 3 | 23 |
| | (1:1) | | | | |
| | 10 wt. % | | | | |
| Exp. 31 | butanol | 81 | 11 | 8 | 19 |
| | (1:1) | | | | |
| | 5 wt. % | | | | |
| Exp. 32 | methanol | 75 | 22 | 3 | 25 |
| | (1:1) | | | | |
| | 15 wt. % | | | | |
| Exp. 33 | none | 85 | 12 | 3 | 15 |

1^{st} PSC wt. %: the weight percentage of the poor solvent components contained in the additive solvent to the solvent in the prepared dope before the addition;
2^{nd} PSC wt. %: the weight percentage of the poor solvent components in the casting dope (after the addition) to the total solvent components of thereof.

The solvent of the casting dope didn't contain ethanol, methylacetate and acetone.

The prepared dope (dope A) contained: (dichloromethane (DCM)):(methanol(MeOH)):(butanol(BuOH))=85 wt. %:12 wt. %:3 wt. %

TABLE 8

| | Adding Condition | | | | | | | | |
|---|---|---|---|---|---|---|---|---|---|
| | Adding | | | | T | G′ | CRS | SR | Re |
| | method | FR | SS | NE | (° C.) | (Pa) | (wt. %) | (%) | (nm) |
| Exp. 28 | Inline | 1.2 | 30 | 48 | −7 | 250,000 | 70 | 104 | 2.5 |
| Exp. 29 | Inline | 1.1 | 30 | 48 | −15 | 250,000 | 70 | 104 | 2.5 |
| Exp. 30 | Inline | 1.3 | 30 | 48 | −7 | 350,000 | 70 | 104 | 2 |
| Exp. 31 | Inline | 1.5 | 30 | 48 | −30 | 250,000 | 70 | 102 | 2.5 |
| Exp. 32 | Batch | — | — | — | — | — | | — | — |

| | | | | | | |
|---|---|---|---|---|---|---|
| Exp. 33 | No additional solvent | −7 | 150,000 | 70 | 113 | 10 |

FR: flow ratio S1/S2, or a ratio of the flow speed S1 (m/min) of the additional solvent 20 to the flow speed S2 (m/min) of the prepared dope 12
SS: sharing speed (1/sec) of prepared dope
NE: number of elements

Tables 7&8 teach that the storage modules G′ of the casting film 33 becomes larger when the concentration or the weight percentage of the poor solvent components is increased by adding the additional solvent 20 into the prepared dope 12. In this case, the film is hardly stretched. Thus the film in which the Re value decreases and optical isotropy is excellent is obtained. Further, the preferable method of adding the poor solvent components is the inline method.

The measurement of the transmittance speed C2 and the infrared absorbance spectrum was made according to relations of physical properties to optical properties of the films obtained in Experiments 28-31.

The transmittance speed C1 of the sonic wave in the transporting direction of the film was 2.60 km/s, and the transmittance speed C2 in a widthwise direction of the film was 2.25 km/s. Note the measurement of the transmittance speeds of the sonic waves were made with the above described device. In the measurement, the polarized light I(A) and I(B) were used. A ratio F1 of the absorbance, A₁₀₅₀(I(A)) to A₁₀₅₀(I(B)), at the wave number of 1050 cm⁻¹ was 1.12, and a ratio F2 of the absorbance, A₁₇₆₀(I(A)) to A₁₇₆₀(I(B)), at the wave number of 1760 cm⁻¹ was 0.88. Note that the measurement of the absorbance was made with use the above described device, and the measurement was made for the each film obtained in Experiment 29-31.

TABLE 9

| | C1 | C2 | | | |
|---|---|---|---|---|---|
| | (km/sec) | (km/sec) | (C1/C2) | F1 | F2 |
| Exp. 28 | 2.60 | 2.25 | 1.15 | 1.12 | 0.88 |
| Exp. 29 | 2.60 | 2.25 | 1.15 | 1.14 | 0.86 |
| Exp. 30 | 2.60 | 2.25 | 1.15 | 1.12 | 0.87 |
| Exp. 31 | 2.60 | 2.25 | 1.15 | 1.1 | 0.78 |

F1 = A₁₀₅₀(I(A))/A₁₀₅₀(I(B))
F2 = A₁₇₆₀(I(A))/A₁₇₆₀(I(B))

Table 9 teaches according to the film produced in Experiments 28-31 that the transmittance speed C1 of the sonic wave in the transporting direction of the film was at most 2.65 km/s, and the transmittance speed C2 in a widthwise direction of the film was at least 2.20 km/s. The ratio (C1/C2) of the transmittance speed was 1.15. The ratio F1 of the infrared spectrum with use of the polarized light of 1050 cm⁻¹ satisfies F1≦1.2, and the ratio F2 of the infrared spectrum with use of the polarized light of 1760 cm⁻¹ satisfies F2≦1. As shown in Table 8, such film has the Re value of 2 nm or 2.5 and is excellent in the optical isotropy.

Various changes and modifications are possible in the present invention and may be understood to be within the present invention.

1. A solution casting method for producing a polymer film whose thickness is from 10 μm to 60 μm, comprising steps of:
casting on a support a dope containing polymer, so as to form a casting film having storage modulus of at least 150,000 Pa; and
peeling said casting film as said polymer film from said support.

2. A solution casting method described in claim 1, wherein a temperature of said support is at least −5° C.

3. A solution casting method described in claim 2, wherein a solvent in said dope cast onto said support contain at least one poor solvent component for said polymer in the range of 5 wt. % and 50 wt. %.

4. A solution casting method described in claim 3, wherein said poor solvent component is added to said dope before the casting.

5. A solution casting method described in claim 4, wherein the addition of said poor solvent component is made in line, and said dope thereafter is mixed by a mixing device.

6. A solution casting method described in claim 5, wherein the addition of said poor solvent component is made such that a percentage of said poor solvent may be at most 20 wt. % to a solvent in said dope before the addition.

7. A solution casting method described in claim 6, wherein said poor solvent component contains alcohol.

8. A solution casting method described in claim 7, further comprising a step of stretching said polymer film such that a stretch ratio of said polymer film in a transporting direction may be at most 110%.

9. A solution casting method described in claim 8,
wherein said stretching is made when a content of said remaining solvent Wr in said polymer film is at least 10 wt. %;
wherein said content of the remaining solvent Wr is defined by a formula, Wr=(Ws/Wf)×100;
wherein when Wf is a weight of said polymer film and Ws is a weight of said solvent contained in said polymer film.

10. A solution casting method for producing a film whose thickness is in the range of 10 μm and 60 μm, comprising steps of:
casting on a support a dope containing polymer, so as to form a casting film;
peeling said casting film as said polymer film from said support; and
stretching said polymer film such that a stretch ratio of said polymer film in a transporting direction may be more than 100% and at most 110%.

11. A solution casting method described in claim 10,
wherein said stretching is made when a content of said remaining solvent Wr in said polymer film is at least 10 wt. %;
wherein said content of the remaining solvent Wr is defined by a formula, Wr=(Ws/Wf)×100;
wherein when Wf is a weight of said polymer film and Ws is a weight of said solvent contained in said polymer film.

12. A solution casting method described in claim 11, wherein said polymer is cellulose acylate.

13. A solution casting method described in claim 12, wherein all solvent components in said dope at the casting are nonchlorine type organic compounds.

14. A polymer film made by casting a solution of a polymer, comprising:
a transmittance speed C1 of sonic wave in a casting direction of casting said solution, a maximum of said transmittance speed C1 being 2.65 km/sec; and
a transmittance speed C2 of sonic wave in a widthwise direction perpendicular to said casting direction, a minimum value of said transmittance speed C2 being 2.20 km/sec.

15. A polymer film described in claim 14, wherein a ratio of said transmittance speed Cl to said transmittance speed C2 is in the range of 0.8<(C1/C2)<1.5.

16. A polymer film described in claim 15,
wherein a polarized light I(A) in said casting direction and a polarized light I(B) in said widthwise direction are used to measure a infrared spectrum;
wherein said infrared spectrum satisfies a condition
A₁₀₅₀(I(A))/A₁₀₅₀(I(B))≦1.2
wherein said A₁₀₅₀(I(A)) is an absorbance at 1050 cm⁻¹ with use of I(A), and A₁₀₅₀(I(B)) is an absorbance at 1050 cm⁻¹ with use of I(B).

17. A polymer film described in claim 16,
wherein a polarized light I(A) in said casting direction and a polarized light I(B) in said widthwise direction are used to measure a infrared spectrum;
wherein said infrared spectrum satisfies a condition,
A₁₇₆₀(I(A))/A₁₇₆₀(I(B))≦1, and
wherein said A₁₇₆₀(I(A)) is an absorbance at 1760 cm⁻¹ with use of I(A), and A₁₇₆₀(I(B)) is an absorbance at 1760 cm⁻¹ with use of I(B).

18. A polymer film described in claim 17,
wherein an in-plane retardation Re is at most 10 nm and defined to a formula of Re=(Nx−Ny)×d, and
wherein Nx is a birefringence in said transporting direction, Ny is birefringence in said thickness direction, and d is a thickness (nm) of said polymer film.

19. A polymer film described in claim 15, wherein said polymer is cellulose acylate.
